(19) United States
(12) Patent Application Publication
(10) Pub. No.: US 2023/0289204 A1
(43) Pub. Date: Sep. 14, 2023

(54) Zero Trust Endpoint Device

(71) Applicant: BedRock Systems. Inc., San Mateo, CA (US)

(72) Inventors: Osman Abdoul Ismael, Annapolis, MD (US); John Walsh, Lutz, FL (US); Allen Warner, Leesburg, VA (US); Joshua M. Dobies, Lafayette, CA (US)

(21) Appl. No.: 18/182,157

(22) Filed: Mar. 10, 2023

Related U.S. Application Data
(60) Provisional application No. 63/318,466, filed on Mar. 10, 2022.

(51) Int. Cl. G06F 9/455; H04L 9/40

(52) U.S. Cl. CPC G06F 9/45558; H04L 63/20; G06F 2009/45591; G06F 2009/45587

(57) ABSTRACT

A computing device includes a virtualized system including: a set of one or more virtual machines (VMs) that execute one or more guest operating systems, a set of one or more virtual machine monitors (VMMs) corresponding to the set of one or more VMs respectively: a formally verified microkernel to abstract hardware resources of the computing device, an isolated environment that is addressable only from the formally verified microkernel, the isolated environment including: a policy manager that manages a set of one or more policies for the virtualized system including installing the set of policies to a policy enforcement point, where the set of policies includes one or more zero trust policies, a confidence level determination engine that calculates a confidence level for a system or user action based at least on inputs including identity information, and provides the calculated confidence level to the policy manager. The policy enforcement point enforces the set of policies.

### CROSS-REFERENCE TO RELATED APPLICATIONS

This application claims the benefit of U.S. Provisional Application No. 63/318,466, filed Mar. 10, 2022, which is hereby incorporated by reference.

### FIELD

Embodiments of the invention relate to the field of virtualization; and more specifically, to a zero trust endpoint device.

### BACKGROUND

Virtualization makes it possible for multiple operating systems (OSs) to run concurrently on a single host system without those OSs needing to be aware of the others. The single physical host machine is multiplexed into virtual machines (VMs) on top of which unmodified OSs (referred to as guest OSs) can run. Conventional implementations include a software abstraction layer between the hardware (which may support full virtualization) and the hosted operating system(s). The virtualization layer translates between virtual devices and the physical devices of the platform. In a fully virtualized environment, a guest operating system (OS) can run a virtual machine without any modifications and is typically unaware that it is being virtualized. Paravirtualization is a technique that makes a guest OS aware of its virtualization environment and requires hooks to a guest OS which requires access to its source code, or a binary translation be performed.

Although virtualization relies on hardware support, a software component called a microkernel runs directly on the hardware of the host machine and exposes the VM to the guest OS. The microkernel is typically the most privileged component of the virtual environment. The microkernel abstracts from the underlying hardware platform and isolates components running on top of it. A virtual machine monitor (VMM) manages the interactions between virtual machines and the physical resources of the host system. The VMM exposes an interface that resembles physical hardware to its virtual machine, thereby giving the guest OS the illusion of running on a bare-metal platform. As compared to the microkernel, the VMM is a deprivileged user component whereas the microkernel is a privileged kernel component.

Virtual Machine Introspection (VMI) is a technique conventionally used to observe hardware states and events and can be used to extrapolate the software state of the host. VMI leverages the property of a VMM that has access to all the state of a virtual machine including the CPU state, memory, and I/O device state.

### SUMMARY

In some aspects, the techniques described herein relate to a computing device, including: a plurality of hardware resources including a set of one or more hardware processors, memory, and storage devices, wherein the storage devices include instructions that when executed by the set of hardware processors, cause the computing device to operate a virtualized system, the virtualized system including: a set of one or more virtual machines (VMs) that execute one or more guest operating systems; a set of one or more virtual machine monitors (VMMs) corresponding to the set of one or more VMs respectively, wherein a particular VMM manages interactions between the corresponding VM and physical resources of the computing device; a formally verified microkernel running in a most privileged level to abstract hardware resources of the computing device; an isolated environment that is addressable only from the formally verified microkernel, the isolated environment including: a policy manager that manages a set of one or more policies for the virtualized system including installing the set of policies to a policy enforcement point, wherein the set of policies includes one or more zero trust policies; a confidence level determination engine that calculates a confidence level for a system or user action based at least on inputs including identity information, and provides the calculated confidence level to the policy manager, wherein the policy manager updates one or more of the set of policies based on the received confidence level; and the policy enforcement point enforces the set of policies.

In some aspects, the techniques described herein relate to a method in a computing device, including: executing a formally verified microkernel in a most privileged level to abstract hardware resources of the computing device; executing a plurality of virtual machine monitors (VMMs), wherein each of the plurality of VMMs runs as a user-level application in a different address space on top of the formally verified microkernel, wherein each of the plurality of VMMs support execution of a different guest operating system running in a different virtual machine (VM), wherein a particular VMM manages interactions between a corresponding VM and hardware resources of the computing device, and wherein the plurality of VMMs are formally verified; detecting through one of the VMMS, a system or user action on the computing device; calculating a confidence level for the system or user action based at least on inputs including identity information; and using the calculated confidence level for enforcement of a zero trust policy on the computing device.

### BRIEF DESCRIPTION OF THE DRAWINGS

The invention may best be understood by referring to the following description and accompanying drawings that are used to illustrate embodiments of the invention. In the drawings:

FIG. 1 is a block diagram that illustrates an exemplary architecture for a zero trust software defined network for use in isolating identity, confidentiality, and permissions for an end point device according to an embodiment.

FIG. 2 shows an exemplary architecture that may be used for the computing device of FIG. 1 according to an embodiment.

FIG. 3 illustrates an exemplary isolated environment for zero trust policy enforcement on the endpoint according to an embodiment.

FIG. 4 shows an example of a zero-trust policy being enforced according to an embodiment.

FIG. 5 shows an example process diagram between various components of the isolated environment for zero trust policy enforcement on the endpoint according to an embodiment.

FIG. 6 illustrates exemplary operations for the integrity monitor according to an embodiment.

FIG. 7 is a block diagram that illustrates policy enforcement according to some embodiment.

FIG. 8 is a flow diagram that illustrates exemplary operations for enforcing a policy according to an embodiment.

FIG. 9 is a flow diagram that illustrates exemplary operations for enforcing register protection according to an embodiment.

FIG. 10 is a flow diagram that illustrates exemplary operations for enforcing a process allow list policy according to an embodiment.

FIG. 11 is a flow diagram that illustrates exemplary operations for enforcing a driver allow list policy according to an embodiment.

FIG. 12 is a flow diagram that illustrates exemplary operations for enforcing a data structure integrity policy according to an embodiment.

FIG. 13 is a flow diagram that illustrates exemplary operations for enforcing code integrity policy according to an embodiment.

FIG. 14 is a block diagram that shows an exemplary implementation for the formally verified trusted computing base as shown in FIG. 2 for an ARM architecture according to an embodiment.

FIG. 15 is a block diagram that shows an exemplary implementation for the formally verified trusted computing base as shown in FIG. 2 for an x86 architecture according to an embodiment.

FIG. 16 is a flow chart that illustrates an exemplary method of formal verification that may be used in some embodiments.

FIG. 17 illustrates an example use of the formally verified trusted computing base with active security and policy enforcement, according to an embodiment.

FIG. 18 illustrates an example use of the formally verified trusted computing base with active security and policy enforcement, according to an embodiment.

FIG. 19 illustrates an example use of the zero trust endpoint device according to an embodiment.

FIG. 20 is a flow diagram that illustrates exemplary operations for zero trust policy enforcement on the endpoint according to an embodiment.

### DESCRIPTION OF EMBODIMENTS

A methodology to isolate critical identity, confidentiality, and permissions for zero trust software defined network end point devices is described. This solution enables the movement of least functionality associated with virtualized environments to true least privilege. Full control over the physical hardware environment enables the ability to restrict access to all resources on an end-point device. The impact of this ability is to have full control over access to physical memory, CPUs, communications, data flow and the associated addressing—internal memory and resources as well as to external (incoming and outgoing).

Identity information can be used as part of the zero trust software defined networking (SDN) end point device solution. The identity information may include identity of the device, identity of a virtual machine, identity of a guest operating system, identity of the application, and/or identity of the user. This allows non-repudiation associated with all data associated with the user.

In an embodiment, an isolated environment (an area of reserved compute resources) is used to calculate and evaluate a confidence level for requests and/or actions based on a corpus of trusted and/or untrusted source data. The isolated environment is sometimes referred herein as a confidence zone. The isolated environment is addressable only from the hypervisor of the formally verified trusted computing base. The confidence level may be published to other entities in the system. The confidence level may be a multidimensional representation of the actions occurring on an end-point device and is based on algorithmic analysis of trusted information against actions being requested by an agent. The agent may be a guest operating system, an application, a user, a network connection, etc. The isolated environment may enable the storage of and algorithmic analysis of a variety of identity, certificates, signatures, policies, permissions, and other relevant information necessary to calculate a confidence level for a given request or action.

The confidence level may be used within the device to do one or more of the following: enable action(s) associated with the guest; enable action(s) associated with other guests on the device; enable action(s) associated with device resources; enable connection(s) and interaction with remote device(s); and enable the ability to receive connection and interaction request(s) from remote devices. In an embodiment, an action is denied unless specifically authorized.

Policies and tokens (e.g., certificates, keys, passwords) can be updated dynamically using an Out-Of-Band (management layer) communication path. This communication path may use software defined networking (SDN). This OOB activity allows for entirely separate cryptographic primitives as well as networks can be utilized that Guest VMs are unable to access.

There may be multiple virtual machines as part of the virtualized system including one or more guest virtual machines and one or more system virtual machines. A guest VM supports an operating system and application(s) necessary for the services the endpoint device provides. For instance, a guest VM may provide specific functionality associated with capabilities or resources (e.g., Internet Of Things sensor) or a User (Human in the loop). A guest application provides the actual capabilities that a software application provides as part of the system functionality. Applications require access to system resources and create information, receive information, or publish to destinations. The zero trust environment described herein restricts what applications are able to accomplish based on identity and permissions being verified prior to execution of an action.

A system virtual machine may include a software defined networking (SDN) VM that provides a layer of abstraction from a standard virtualized guest environment. The formally verified trusted computing base provides an isolated VM environment and all network connections from the other hosted guests are routed through the SDN VM to manage communication paths and enable fine grain control over source and destination using multiple virtual switches that are configured to support internal communication paths. For instance, a first virtual switch may be configured to allow communication between a first set of one or more VMMs and VMs, and a second switch may be configured to allow communication only between a second set of one or more VMMs and VMs. In this case, since multiple SDN connections may be in existence simultaneously, guests only receive what they are approved to receive and are unable to gain any insights into other traffic in/out of the device as well as transiting to other guests.

The formally verified trusted computing base supports isolated virtualization. Because of this, the SDN VM that supports a SDN application can integrate with a variety of SDN solutions such as credential-based routing and block chain identity. The SDN application can use identities between source and destination points. Further, the endpoint described herein can protect the identity source information (e.g., certificates, signature, cryptographic primitives, etc.) from exploitation associated with malware that either exists on the system or is installed on the system via a variety of methods, which conventional SDN approaches cannot protect against.

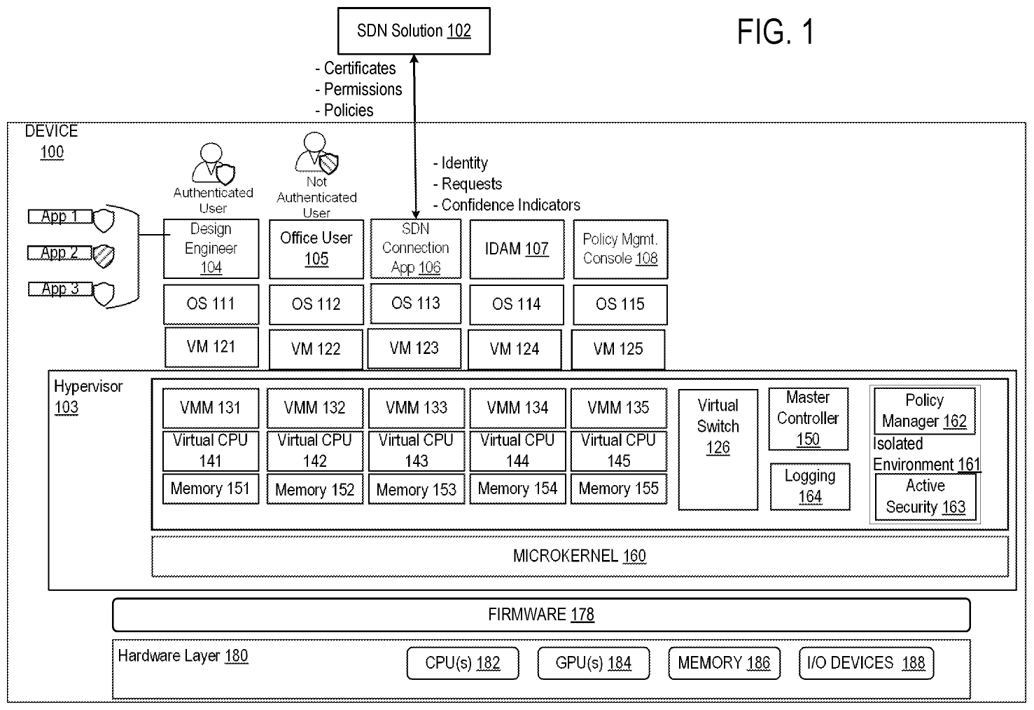

FIG. 1 is a block diagram that illustrates an exemplary architecture for a zero trust software defined network for use in isolating identity, confidentiality, and permissions for an end point device according to an embodiment.

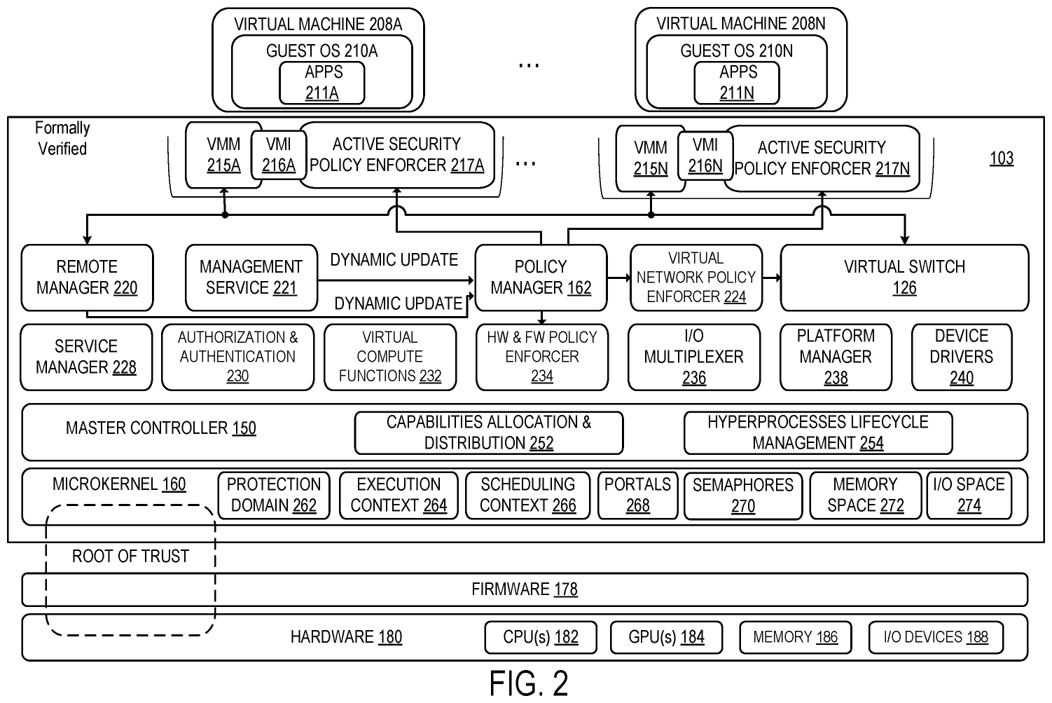

The computing device 100 may be any type of computing device such as a desktop computer, a laptop computer, a server computer, a mobile device such as a smartphone or tablet, a wearable device, a set-top box, a medical computing device, a gaming device, an internet-of-things (IoT) device, or any other computing device that can implement a virtualized system. FIG. 2 shows an exemplary architecture that may be used for the computing device 100.

The computing device 100 executes a hypervisor 103. The hypervisor 103 is the provider of the virtualization infrastructure necessary to a trusted computing base. The hypervisor 103 and other components provide a formally modeled foundation that is designed to function correctly under all conditions and provides the ability to tightly manage, monitor, and orchestrate the actions of guest operating systems, applications, and users, that are associated with hosted virtual machines. Guests, applications, and users are associated with hosted virtual machines.

The virtualized system includes one or more guest VMs and may include one or more system VMs. For example, FIG. 2 shows one or more guest operating systems 210A-N and guest applications 211A-N respectively running on top of one or more virtual machines 208A-N respectively. The guest OS and applications may be unmodified. In the example of FIG. 1, VM 121 and VM 122 are guest VMs on which OS 111 and OS 112 are running respectively. Multiple guest applications may be running on top of an OS. For instance, an authenticated user (a design engineer 104) is allowed to use the application 1 and application 3 but not application 2. An unauthenticated user (the office user 105) is shown as executing application(s) on the OS 112. The VM 123 is a system VM that supports running the SDN connection application 106 on top of OS 113 that connects over a network to the SDN solution 102. VM 124 is a system VM that supports an IDAM application 107 running on top of OS 114. VM 125 is a system VM that supports a policy management console 108 running on top of OS 115. The policy management console 108 is implemented on a system level VM that is not exposed on the device 100, but provides a remote administrator the ability to remotely connect and make changes to the actual policies on the device. This may occur as part of the 00B management.

In an embodiment, each virtual machine has a separate virtual machine monitor (VMM), separate virtual CPU, and separate memory. For example, the VMs 121-125 have separate VMMs 131-135, virtual CPUs 141-145, and memory 151-155 respectively. Each VMM may use h virtual machine introspection (VMI) and separate active security policies, which ensures maximum process and memory segregation. For example, the virtual machines 208A-N have a separate VMM 215A-N with VMI 216A-N respectively, and separate active security policy enforcers 217A-N. This separation provides a level of protection even against bugs in the hardware as the memory of each VM is mapped into a specific isolated memory space and no memory from other VMMs and their VMs can be read.

Each VMM 131-135 runs as a user-level application in an address space on top of the microkernel 160 and supports the execution of the guest OS (e.g., an unmodified guest OS) running in a virtual machine. Each VMM 131-135 emulates sensitive instructions and provides virtual devices. Each VMM 131-135 manages the guest-physical memory of its associated virtual machine by mapping a subset of its own address space into the host address space of the VM. Each VMM 131-135 can translate the guest virtual addresses to guest physical addresses. Each VMM can configure/modify access permissions of individual guest physical addresses in the system's second level address translation tables (slats). Each VMM 131-135 can also map any of its I/O ports and memory-mapped I/O (MMIO) regions into the virtual machine to grant direct access to a hardware device. For example, a VMM creates a dedicated portal for each event type and sets the transfer descriptor in the portals such that the microkernel 160 transmits only the architectural state required for handling the particular event. For example, the VMM configures the portal corresponding to the CPUID instruction with a transfer descriptor that includes only the general-purpose registers, instruction pointer, and instruction length.

When a VM-exit event occurs, the microkernel 160 sends a message to the portal corresponding to the VM-exit event and transfers the requested architectural state of the virtual CPU to the handler execution context in the VMM. The VMM determines the type of virtualization event from the portal that was called and then executes the correct handler function. To emulate instructions such as CPUID, the VMM loads the general-purpose registers with new values and advances the instruction pointer to point behind the instruction that caused the VM exit. The VMM transmits the updated state to the microkernel 160 and the virtual CPU can resume execution.

Each VMM 131-135 provides one or more virtual devices for its guest OS. Each virtual device is modeled as a software state machine that mimics the behavior of the corresponding hardware device. When an instruction reads from or writes to an I/O port or memory-mapped I/O register, the VMM updates the state machine of the corresponding device model in a like way as the physical hardware device would update its internal state. When a guest OS wants to perform an operation such as a disk read, the VMM contacts the device driver for the host device to deliver the data.

If a virtual CPU 141-145 performs a memory-mapped I/O access, a VM-exit event occurs. The microkernel 160 sends a fault message to the corresponding VMM because the region of guest-physical memory corresponding to the disk controller is not mapped in the host address space of the virtual machine. The VMM decodes the instruction and determines that the instruction accesses the virtual disk controller. By executing the instruction, the VMM updates the state machine of the disk model. After the guest operating system has programmed the command register of the virtual disk controller to read a block, the VMM sends a message to the disk server to request the data. The device driver in the disk server programs the physical disk controller with a command to read the block into memory. The disk driver requests a direct memory access (DMA) transfer of the data directly into the memory of the virtual machine. It then returns control back to the VMM, which resumes the virtual machine. Once the block has been read from disk, the disk controller generates an interrupt to signal completion. The disk server writes completion records for all finished requests into a region of memory shared with the VMM. Once the VMM has received a notification message that disk operations have completed, it updates the state machine of the device model to reflect the completion and signals an interrupt at the virtual interrupt controller. During the next VM exit, the VMM injects the pending interrupt into the virtual machine.

A particular VMM has full visibility into the entire guest state of its corresponding virtual machine including hardware state (e.g., CPU state (e.g., registers), GPU state (e.g., registers), memory, I/O device state such as the contents of storage devices (e.g., hard disks), network card state, register state of I/O controllers, etc.), application and OS behavior, and code and data integrity. Virtual Machine Introspection (VMI) is performed to inspect the guest and has visibility of every system call, resource access, and application/process launch and termination. For example, the VMM can program the hardware to trap certain events which can be used by the VMI to take and inspect the guest's state at that moment. Thus, the VMM can inspect all interactions between the guest software and the underlying hardware.

The microkernel 160 of the hypervisor 103 may be a lightweight microkernel running at the most privileged level as required by its role to abstract hardware resources (e.g., the CPU) with a minimum interface, and may have less than 10 kloc of code. The hardware layer 180 of the computing device 100 includes one or more central processing units (CPUs) 182, one or more graphics processing units (GPUs) 184, one or more memory units 186 (e.g., volatile memory such as SRAM or DRAM), and one or more input/output devices 188 such as one or more non-volatile storage devices, one or more human interface devices, etc. The hardware components are exemplary and there may be fewer pieces and/or different pieces of hardware included in the system. For instance, the hardware 180 may not include a GPU. Sitting atop the hardware 180 is the firmware 178. The firmware 178 may include CPU microcode, platform BIOS, etc.

The microkernel 160 drives the interrupt controllers of the computing device 100 and a scheduling timer. The microkernel 160 also controls the memory-management unit (MMU) and input-output memory-management unit (IOMMU) if available on the computing device 100. The microkernel 160 may implement a capability-based interface. In an embodiment, the microkernel 160 is organized around several kernel objects including a protection domain 262, execution context 264, scheduling context 266, portals 268, and semaphores 270. For each new kernel object, the microkernel 160 installs a capability that refers to that object in the capability space of the creator protection domain. A capability is opaque and immutable to the user, and they cannot be inspected, modified, or addressed directly. Applications access a capability through a capability selector which may be an integral number that serves as an index into the protection domain's capability space. The use of capabilities leads to fine-grained access control and supports the design principle of least privilege among all components. In an embodiment, the interface to the microkernel 160 uses capabilities for all operations which means that each protection domain can only access kernel objects for which it holds the corresponding capabilities.

Running on top of the microkernel 160 are multiple hyper-processes. Each hyper-process runs as a separate protected and microkernel 160 enforced memory and process space, outside of the privilege level of the microkernel 160. In an embodiment, each hyper-process is formally verified. Some of these hyper-processes communicate with the microkernel 160 such as the master controller 150. The master controller 150 controls the operation of the virtualization such as memory allocation, execution time allotment, virtual machine creation, and/or inter-process communication. For instance, the master controller 150 controls the capabilities allocation and distribution 252 and the hyperprocesses lifecycle management 254 that manages the lifecycle of hyper-processes.

A capability is a reference to a resource, plus associated auxiliary data such as access permissions. A null capability does not refer to anything and carries no permissions. An object capability is stored in the object space of a protection domain and refers to a kernel object. A protection domain object capability refers to a protection domain. An execution context object capability refers to an execution context. A scheduling context object capability refers to a scheduling context. A portal object capability refers to a portal. A semaphore object capability refers to a semaphore. A memory object capability is stored in the memory space 272 of a protection domain 262. An I/O object capability is stored in the I/O port space 274 of a protection domain 262 and refers to an I/O port.

A remote manager 220 may be part of the hypervisor 103. It may be a single point of contact for external network communication for the computing device 100. The remote manager 220 can define the network identity of the computing device 100 by implementing the TCP/IP stack and may also implement the TLS service for cryptographic protocols designed to provide secure communications over the network. In an embodiment, the remote manager 220 validates the network communication (an attestation of both endpoints).

The virtual switch 126 implements a virtual switch element. The virtual switch 126 emulates a physical network element and allows for external network communication for guest operating systems or guest applications depending on the network configuration. The virtual switch 126 may also allow network communication between guest operating systems or guest applications depending on the configuration of the virtual switch 126. Although the term “switch” has been used, in some embodiments the virtual switch 126 can see through L7 of the OSI model. As will be described in greater detail later herein, virtual network policies may be applied to the virtual switch 126.

A service manager 228 may be part of the hypervisor 103 that allows hyper-processes to register an interface (functions that they implement) associated with a universally unique identifier (UUID). For example, device drivers may register a serial driver with the service manager to provide a universal asynchronous receiver-transmitter (UART) service with its UUID. An I/O multiplexer 236 (e.g., a UART multiplexer) can request the service manager access to that service to use the serial port. An authorization and authentication 230 hyper-process can define user credentials with their associated role for access control to all the exported functions of the virtualized system.

A management service 221 may expose the management functions to the outside world. The management service 221 exposes an application programming interface (API) that can be consumed by third party device managers. The exposed functions may include inventory, monitoring, and telemetry, for example. The management service 221 may also be used for configuring policies.

Virtual compute functions 232 may implement the lifecycle of the VM including creating a VM, destroying a VM, starting a VM, stopping a VM, freezing a VM, creating a snapshot of the VM, and/or migrating the VM. The I/O multiplexer 236 is used to multiplex I/O device resources to multiple guests. As described above, the I/O multiplexer 236 can request the service manager 228 for access to a registered interface to use the particular I/O device.

A platform manager 238 provides access to the shared and specific hardware resources of a device, such as clocks that are used by multiple drivers, or power. A hyper-process cannot directly shutdown or slow down a CPU core since it may be shared by other hyper-processes. Instead, the platform manager 238 is the single point of decision for those requests. Thus, if a hyper-process wants to shut down or slow down a CPU core, for instance, that hyper-process would send a request to the platform manager 238 which would then make a decision on the request.

Device drivers 240 control access to the drivers of the computing device 100. The device drivers 240 may include a driver for a storage device, network adapter, sound card, printer (if installed), video card, USB device(s), UART devices, etc.

Active security 163 with policy enforcement may be performed by the virtualized system according to an embodiment. The active security and policy enforcement is performed in coordination with the policy manager 162 and one or more policy enforcers such as the active security policy enforcers 217A-217N (using the VMI 216A-216N respectively), the virtual network policy enforcer 224, and the hardware and firmware policy enforcer 234. In an embodiment, the policies that can be enforced includes active security policies, virtual network policies, hardware and/or firmware policies, and zero trust policies. The policies may be formally verified.

An active security 163 policy enforces the behavior of a guest OS or guest application. Example active security policies include: process allowance, process denial, driver allowance, driver denial, directory allowance, directory denial, file type allowance, file type denial, I/O device allowance, I/O device denial, limiting the number of writes to a particular register and/or limiting the values that can be in a particular register, and protecting a memory page (e.g., limiting writes or reads to specific memory pages, ensuring the memory is not executed).

A virtual network policy enforces the behavior of the network of the computing device 100 (e.g., affects transmitting data outside of the computing device 100 and/or receiving data into the computing device 100). Example virtual network policies include: source/destination MAC address allow/deny lists, source/destination IP address allow/deny lists; domain allow/deny lists, port allow/deny lists, protocol allow/deny lists, physical layer allow/deny lists (e.g., if a network adapter is available for a particular process or guest application), L4-L7 policies (e.g., traffic must be encrypted; traffic must be encrypted according to a certain cryptographic protocol, etc.), and documents subject to a data loss prevention (DLP) policy. These are example policies and other policies may be created that affect transmitting data outside of the computing device 100 and/or receiving external data into the computing device 100.

Hardware or firmware policies enforce configurations of host hardware configurations/functions and/or host firmware configuration. For instance, a policy may be enforced to require a particular BIOS configuration.

A zero trust policy is a policy that considers identity of the device, the VM, the guest OS, the application, and/or the user. For instance, a zero trust policy may specify that a particular user (or a group of users with a same domain identity) are permitted to access a particular application, VM, and/or resource.

Enforcement of some of the policies may use VMI. A VMI hyper-process is used to inspect the corresponding guest from the outside of the guest. The VMI hyper-process has access to the state of the guest including the CPU(s) 182, GPU(s) 184, memory 186, and I/O devices 188 in which the guest is using. A VMI hyper-process may include a semantic layer to bridge the semantic gap including reconstructing the information that the guest operating system has outside of the guest within the VMI hyper-process. For instance, the semantic layer identifies the guest operating system and makes the location of its symbols and functions available to the VMI hyper-process. In some embodiments, the VMI hyper-process monitors the system calls of the guest. A system call facilitates communication between the kernel and user space within an OS. The VMI hyper-process may request the corresponding VMM to trap one or more system calls to the VMI hyper-process.

The policy manager 162 manages policies for the virtualized system as will be described in greater detail below. As an example, a policy may dictate which drivers may be loaded in the guest kernel; or a policy may dictate which guests can be in the same virtual local area network (VLAN). The policies may include active security policies, virtual network policies, hardware and/or firmware policies, and/or zero trust policies. The policies may be different for different guest operating systems or applications. For instance, a policy for a first guest operating system may allow network communication whereas a policy for a second guest operating system may not allow network communication.

The policies may be configured locally using a management service and/or remotely using the remote manager or may be configured locally on the computing device 100. For instance, if it is determined that there is a domain that is serving malware, a remote server can transmit a policy to the remote manager that specifies that access to that particular domain should be prevented. The remote manager then sends the policies to the policy manager 162. The policy manager 162 installs the policies to one or more policy enforcement points that are referred to as policy enforcers. Example policy enforcers include the active security policy enforcers (there may be one active security policy enforcer per VMM or a single active security policy enforcer for multiple VMMs), a virtual network policy enforcer, and a hardware and firmware policy enforcer. The policies may be received and installed dynamically.

For instance, upon boot, the policy manager 162 may consume a policy configuration file and use it to configure policy for the policy enforcer. The policies may be used to protect VMM configurations, and monitor and respond to violations in one or more of: virtual memory areas; kernel; system call table; vector call tables; driver modules; Berkely packet filters; trap unknown actions; and system semantics.

The policies may have a user component and/or a time component. For instance, a virtual network policy may specify that a particular domain cannot be reached at a certain time of the day (e.g., overnight). As another example, a virtual network policy may specify that a particular application is allowed network connectivity at only certain times during the day. As another example, a virtual network policy may specify the domains in which a particular user of the guest operating system can access or cannot access, which may be different from another virtual network policy for another user of the guest operating system. As another example, a hardware policy may specify that a particular file or directory cannot be accessed by a guest operating system or application (or potentially a process) during a specific time.

The policy manager 162 may also configure the virtual switch 126 through the virtual network policy enforcer 224. For instance, the policy manager 162 may send a network configuration to the virtual network policy enforcer 224 for configuring virtual Ethernet devices and assigning them to particular VMs, configuring virtual LANs and assigning particular virtual Ethernet devices, etc. The virtual network policy enforcer 224 in turn configures the virtual switch 126 accordingly.

The policies may include hardware and/or firmware policies for enforcing configuration of host hardware configurations/functions and host firmware configuration and function. The hardware and/or firmware policies may be enforced by the hardware and firmware policy enforcer 234. A hardware policy may affect one or more of the CPU(s), GPU(s), memory, and/or one or more I/O devices. As an example, a policy may be enforced to require a particular BIOS configuration.

The preceding example policies are exemplary and not exhaustive. Other types of policies may be implemented by the virtualization layer.

The policy manager 162 manages active security policies for the virtualized system as described herein. In an embodiment, the policy manager 162 is event driven. For instance, the policy manager 162 enforces policy statements that indicate what action to take when a specified event occurs. The policy manager 162 may push event policies to policy enforcers such as the active security policy enforcers 217A-N, the virtual network policy enforcer 224, and/or the hardware and firmware policy enforcer 234, that may result in the policy enforcers generating and transmitting events to the policy manager 162. As an example, the policy manager 162 may enforce a policy that defines if a certain event is received, the policy manager 162 is to isolate the isolating VM from the network. For instance, the policy manager 162 may instruct a particular VMI to enforce a process allow list and to generate a process event if the allow list is violated (a process not on the allow list is created) and transmit the event to the policy manager (or the policy manager could poll the policy enforcers for events). Upon receipt of such a process event, the policy manager may issue an action request to the virtual network policy enforcer to cause the virtual switch 126 to remove the VM from the network (e.g., prevent the VM from accessing the network).

In an embodiment, a policy for a policy enforcer takes the form of: <EVENT>, [<ARG[0]>, . . . ], do [<ACTION[0]>, . . . ]. The Event parameter defines the name of the event, the Argument list defines the arguments provided to the event producer, and the Action list defines one or more actions the policy enforcer takes if the event is produced. By way of example, a file allow list event policy may be defined to apply to a particular process (e.g., which may be identified by a directory that contains the executable file in question), allow that process to read files from a particular directory, and allow that process to read files with a particular file extension, and if that process attempts to read files from either a different directory or from that directory but with a different file extension, the policy enforcer may execute the one or more actions (such as sending an event to the policy manager, blocking the attempted read, etc.).

In an embodiment, a policy for the policy manager 162 takes the form of: on <EVENT> if <FILTER> do [<ACTION>, . . . ]. A filter, which is optional in some embodiments, allows for further conditions to be put on the event. A filter could be a function that always returns true if the condition(s) are satisfied. For instance, a filter could be defined that returns true only once an event has been received a certain number of times (e.g., five times) and potentially over a certain time period. This allows the policy manager to make stateful decisions that may be shared across rules. The policy manager may take one or more actions as defined in the action list of the policy. Each action may be defined by a tuple that takes the form of: (executor, action). The executor specifies which entity should carry out the specified action. The executor may be the policy manager itself or a particular policy enforcer (e.g., active security policy enforcer, virtual network policy enforcer, hardware and firmware policy enforcer). The policy statements and actions in the access list are typically considered in order.

An action to be performed may be requested as an action request. An action request is an asynchronous request made by the policy manager. An action request includes the action requested and may include one or more parameters to specify how to execute the action. For example, a Kill Task action may include a process identifier (pid) parameter that specifies which task to terminate. Depending on the particular action, action requests can be sent to policy enforcers (e.g., ASPE, virtual network policy enforcer, hardware and firmware policy enforcer) or be carried out by the policy manager itself. For instance, the policy manager may perform a log event action request itself. Policy enforcers accept action requests and perform the requested actions. Performing an action may cause one or more additional actions to be performed. For instance, an active security policy enforcer may offer a Kill Task action, and the virtual network policy enforcer may offer an update VLAN configuration action. An action request may result in the generation of new events, which can be sent to the policy manager. These can be sent asynchronously and the policy manager may consider these for its own policy.

Some events may require the policy enforcer to wait for acknowledgement before proceeding. In such a case, the policy manager 162 responds to the event with an acknowledgement action for which the policy enforcer waits to receive before continuing.

In an embodiment, the policy manager 162 pushes a new or updated policy to a policy enforcer or revokes an existing policy installed at a policy enforcer by sending an update policy action to the policy enforcer. The update policy action includes the policy for the particular policy enforcer.

In some embodiments, communication between the policy manager and policy enforcers uses a publish/subscribe model. For instance, events and action requests can be assigned a unique message ID and handlers can be registered in the policy manager to handle incoming events and handlers can be registered in the policy enforcers to handle action requests.

The logging 164 collects all events that trigger either a “Block” or “Log” action in response to specific policies. The active security 163 is used to enforce policies that are designed to identify behaviors that are indicators of potential threats. The active security policies may be configured to “block” or “log” actions and are generally based on allow or deny lists. The active security policies may include policies based on attacks that enable root access to guest operating systems, for example.

In an embodiment, the endpoint device is configured to implement a trusted boot. There are many avenues of potential subversion that are available when booting an operating system and the installed applications. In conventional secure boot implementations, each application has been signed and is verified during the boot process. While this approach is good, there are still numerous subversion opportunities in conventional secure boot implementations. In a conventional trusted boot process, the image has been signed and encrypted by the provider. The endpoint device has the necessary cryptographic capabilities to decrypt the image at boot time and verify the signed image has not changed prior to full boot. Again, while this approach is good, there remains a problem in that the image that is booted is an image that has not necessarily been proven to be defect free and therefore is not trustworthy. In an embodiment, the endpoint device is configured for trusted boot where it boots into a formally verified trusted computing base and then boots the untrusted guest images in virtual machines that are configured based on least functionality and least privilege.

The formally verified TCB of FIG. 1 includes an isolated environment 161. The isolated environment 161 is addressable only from the hypervisor of the formally verified TCB. The isolated environment is used to calculate and evaluate a confidence level for requests and/or actions based on a corpus of trusted and/or untrusted source data. The confidence level may be published to other entities in the system. The confidence level may be a multidimensional representation of the actions occurring on an end-point device and is based on algorithmic analysis of trusted information against actions being requested by an agent. The agent may be a guest operating system, an application, a user, a network connection, etc. The isolated environment may enable the storage of and algorithmic analysis of a variety of identity, certificates, signatures, policies, permissions, and other relevant information necessary to calculate a confidence level for a given request or action. The confidence level may be used within the device to do one or more of the following: enable action(s) associated with the guest; enable action(s) associated with other guests on the device; enable action(s) associated with device resources; enable connection(s) and interaction with remote device(s); and enable the ability to receive connection and interaction request(s) from remote devices. In an embodiment, an action is denied unless specifically authorized.

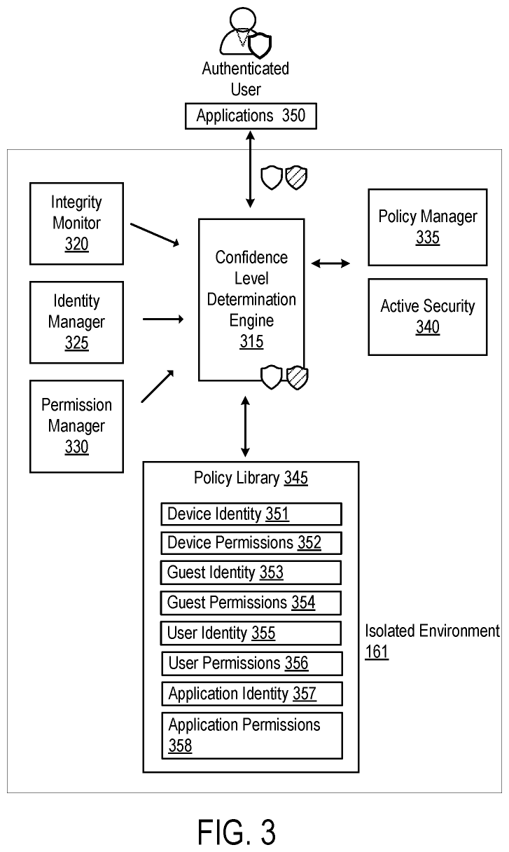

FIG. 3 illustrates an exemplary isolated environment for zero trust policy enforcement on the endpoint according to an embodiment. The isolated environment 161 includes the confidence level determination engine 315, the integrity monitor 320, the identity manager 325, the permission manager 330, the policy manager 335, the active security 340, and the policy library 345. The policy manager 335 is like the policy manager 162 and the active security 340 is like the active security 163.

The confidence level determination engine 315 evaluates inputs from internal device information and/or external information to calculate a relative confidence level for a system or user action. Example inputs, either direct or indirect, include input from the integrity monitor 320, identity manager 325, permission manager 330, active security 340, policy library 345, and/or applications 350. As an example, access to a particular resource, VM, and/or functionality, may be based on combined identity (a composite identity).

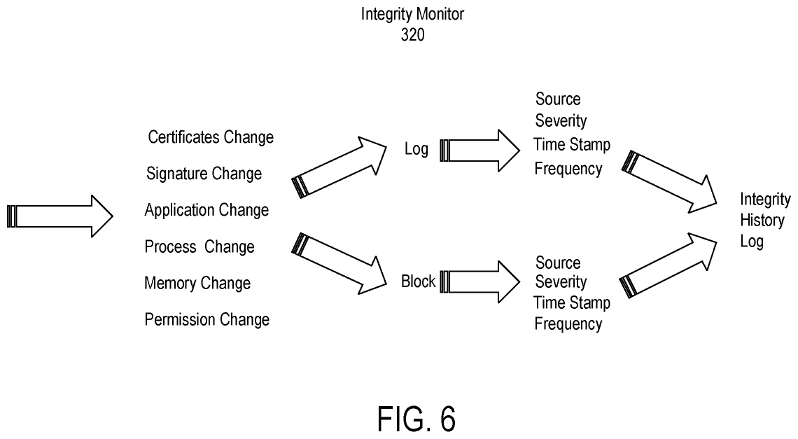

The integrity monitor 320 analyzes log data such as identifying occurrences when system elements (user, applications, operating systems, and/or resources) attempt to circumvent any policy configuration associated with the identity information (e.g., certificates, signatures, permissions). This information can be flagged and evaluated by the confidence level determination engine 315. The integrity monitor 320 can trigger on any Log or Block that is associated with identity and/or permissions associated with system or guest elements. FIG. 6 illustrates exemplary operations for the integrity monitor 320 according to an embodiment. For example, the integrity monitor 320 analyzes log or block data for certificate changes, signature changes, application changes, process changes, memory changes, and/or permission changes, including the source, severity, time stamp, and/or frequency of any such change.

The identity manager 325 solicits identity information. The solicitation may occur during start-up, operations, and/or whenever new identity information is generated. The identity information may be communicated to the policy library 345 (e.g., pushed by the identity manager 325 to the policy library 345 or pulled by the policy library 345). The identity information may be communicated during system initialization (as necessary) and if updated from the system (which may be subject to analysis of the confidence level determination engine prior to the update being communicated or written to the policy library). In an SDN implementation, the identity related information may be in the form of certificates, signatures, tokens, or even segments of block chain—all of which may be updated as frequently as every write, read, execute, or packet send/receive. The identity manager 325 may retain information in a First In First Out (FIFO) buffer for each guest/resource being managed.

The permission manager 330 tracks and maintains permissions during start-up, operations, and whenever new permission information is received. For instance, the permission manager 330 may provide for an allow or deny for all system elements being managed or monitored. As an example, if a VMM or virtual switch configuration restricts a permission via boot configuration, no modifications to “allow” an action can be executed without updating the boot configuration and then re-booting the device. This is part of the default Deny by default, allow by exception design of the formally verified trusted computing base. The confidence level determination engine can enhance or restrict permissions based on real-time criteria vs. the limitations set at boot time. The permission manager permits policies to be dynamic based on inputs from elements of the system. The permission information is communicated to the policy library 345 (e.g., pushed by the permission manager 330 to the policy library 345 or pulled by the policy library 345).

The policy library 345 is used for generating the confidence level determination. The policy library 345 may include device identity 351, device permissions 352, guest(s) identity 353, guest(s) permissions 354, user(s) identity 355, user(s) permissions 356, application(s) identity 357, and/or application(s) permissions 358. The policy library 345, as part of the isolated environment 161, is in fenced memory that is reserved for storing these permissions and identities.

The device identity 351 may include the MAC address of the device, device identity information that is extracted from the CPU, information contained in BIOS/UEFI, and/or information contained in FPGA silicon. Additionally, or alternatively, the device identity information can include cryptographic based certificates/keys that are loaded in other silicon on the CPU or the device itself such as external credential devices.

The device permissions 352 may include the configuration file of the formally verified trusted computing base and/or information gathered as the device builds connections with SDN end-points. These permissions can be modified based on time, space, and/or permissions associated with the guests, users, applications, and/or connections to system resources. The device permissions 352 may also depend on credentials/certificates that are presented via external resources and/or the calculated confidence level from external management plane capabilities provided via the SDN VM. The device permissions 352 may be subject to the assessed integrity of the boot process, such as was the boot image encrypted and decrypted in a well-formed process, did the necessary hash/certificate checks occur and pass, etc.

The guest(s) identity 353 information includes the result of a validation of a hash and signature of the booted guest operating system in the VM. Mapping this information to specific system memory allocated to the guest that should not change during a session. The contents of the unchanging memory can be hashed page by page and a relationship is set between the boot image hash and the allocated memory hash, which provides assurance of identity to the guest as well as assurance that a change will be detected and a change in confidence level will be made.

The guest(s) permissions 354 are controlled by policies that enable verification and validation of system actions. Guest permissions 354 include what virtual devices are allocated to the guest as well as the virtual resources allocated to the devices. The allocation of physical resources to each guest are maintained as part of the VMM configuration. While some of the permissions for a guest come directly from the VMM configuration, other permissions can be managed by the Active Security policies instantiated during boot time. Updates to active security policies can be pushed by a guest administrator and may include a variety of access control updates.

User identity 355 may take one or more forms. For instance, a user may be a physical person or a user may be an external device that is relying of the functionality associated with the applications/communications hosted in a particular guest. The user identity may include information related to specific tokens, certificates, signatures, etc. The user identity may be generated based on query/response tied with multi-factor authentication actions. User identity 355 information may change during a particular session based on the information received from the SDN management plane and/or assessments regarding trust and the results of the confidence level determination engine 315.

The user permissions 356 generally start with a baseline that is received and established upon successful authentication with a back-end Identity and Access Management (IDAM) capability. The user permissions may be continually evaluated by the confidence level determination engine 315 to assess the suitability of the permissions relative to the Confidence Level change. Permissions may include Read/Write/Execute/Connect/Disconnect/Open/Close/Request/Access/Publish/Deny based on the actions attempted.

Application identity 357 identifies an application. The secure boot process uses the verification of signatures associated with an application during the boot process. While the application state might change during run-time, a change in name of the application may be prevented by the system as part of policy enforcement. Retention of the application name, boot signature, and other information enables retention of the identity of all applications that are “Allowed” as part of a guest configuration. Application identity 357 information is associated with permissions and changes will be evaluated by the confidence level determination engine 315 with corresponding response.

Application permissions 358 are assigned either as part of the boot process based on pre-configurations, based on validity of application signatures, based on guest identity/permissions, based on external input from SDN VM management, or based on real-time confidence level results.

The confidence level determination engine 315 can be fine-tuned to enable or disable source and destination actions and/or increase or decrease the frequency of calculations. For instance, a calculation may be performed for every system call, network call, at session initialization, periodic times during a session, when specific information/triggers are identified by active security and/or are captured in the formally verified trusted computing device that cause the need to recalculate.

Determination may be configured for hard decision criteria as well as soft criteria that has a sliding scale based on organizational policies for end point device usage. Hard decisions include a logical AND of all decision criteria to receive a confidence level of either 0 or 1. Sliding scale base would encompass historical data as well as real time information along with weighting for select information and utilize an algorithm to generate a confidence level with a range between 0 and 1. In both cases, policies would be modified to reflect the confidence level as well as change permissions associated with specific identities.

The granularity of the formally verified trusted computing provides deeper trusted insights into system function and performance than other solutions can provide. The trusted insights, directly impact the ability to manage fine grain policies that can be enforced enabling the detection of changes to individual bits in run-time along and resultant system response.

The integration with SDN solutions as part of enterprise zero trust provides higher confidence and trust in identity/non-repudiation/authentication between end-point devices and back-end infrastructure. The identity information can be provided directly to a trusted confidence zone for storage and assessment by the confidence level determination engine 315. The retention of history for a period can also be used to generate moving averages to support trend-based assessments that may also be rolled into the confidence level.

The confidence level determination engine 315 assigns confidence levels for actions thereby essentially creating value estimates associated with user actions both on the local device as well as back-end devices (source and destination). These confidence levels can be used to update permissions and policies locally and provide coherent instant in time assessment information for back-end analysis that is substantially more valuable and precise than attempting to analyze syslog data for trends.

A confidence level can be established based on a composite score generated on a list of criteria or components/factors associated with multiple identity information. Each identity criteria can be assigned a score (e.g., based on whether that criteria has been met) and that score can be compiled into a composite score. A confidence level can be established based on this composite score. The confidence level can be mapped to a permission. In an embodiment, there may be multiple policy libraries that map to a confidence score/level (e.g., different policy libraries for different destinations). Thus, the combination of identity and confidence level can be mapped to multiple destination associated policy and/or permissions. For example, there may be a composite identity score and associated confidence level for making a request to a first destination with a specific policy/permission that associates at that location; and a second instance for making a request to a second destination that has a different policy/permission for the identity score and associated confidence level.

Embodiments described herein improve the foundation of zero trust and software defined networking by managing isolation, identity, and permissions in endpoint devices. Conventional products suffer from the inherent vulnerability associated with isolation (e.g., single domain devices cannot isolate the network stack from the operating systems and applications running on the same physical hardware). Further, conventional virtualized environments results in an inability to fully isolate across a device and when isolation fails, then protection of critical identity and permissions can be subverted. Unlike these conventional solutions, the formally verified trusted computing base provides the necessary foundation to isolate functionality in a virtualized system based on the capabilities designed into the product and proven correct by formal verification. The formally verified trusted computing base provides isolation to establish a confidence zone where identity and permissions can be stored and assessed to create a confidence level indicator to increase fine grain control over actions being taken by the device, guest, application, user, and others. An advantage provided is the utilization of the confidence zone that is inaccessible to all standard guests on the device, able to execute without interference, able to update device policies as necessary, and able to communicate on Out-Of-Band (OOB) Management channels that are “invisible” to the other guests using the end-point device.

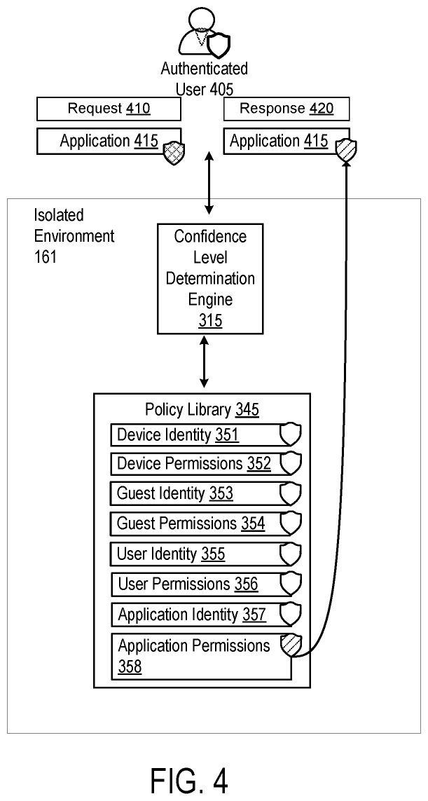

FIG. 4 shows an example of a zero-trust policy being enforced according to an embodiment. The shield icons in the policy library 345 for the different types of identity indicate whether the action or request satisfy the policy for those different identities. In the illustrated example, a shield that does not have a pattern fill indicates that the action or request satisfies the policy; and a shield that has a diagonal pattern fill indicates that the action or request does not satisfy the particular policy. As shown in FIG. 4, the request 410 or action for the application 415 from the authenticated user 405 satisfies the device identity 351, device permissions 352, guest identity 353, guest permissions 354, user identity 355, user permissions 356, application identity, 357, but does not satisfy the application permissions 358. Accordingly, even though the user has been authenticated, the response 420 does not satisfy each policy and therefore mitigation action(s) may be taken (e.g., the response 420 may be blocked, the policy violation may be logged, and/or an alert may be logged and/or transmitted).

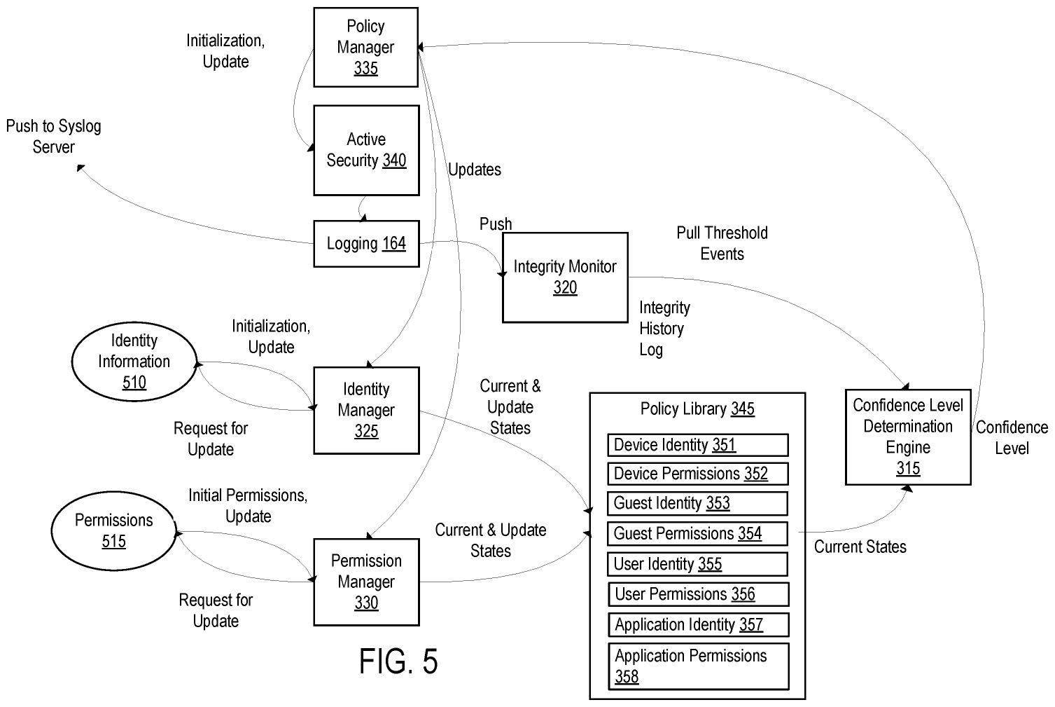

FIG. 5 shows an example process diagram between various components of the isolated environment for zero trust policy enforcement on the endpoint according to an embodiment. As shown in FIG. 5, the policy manager 335, upon boot, may consume a policy configuration file and use it to configure policy for the active security 340, the identity manager 325, and the permission manager 330.

The identity manager 325 solicits identity information 510, which may occur during initialization and/or update. The identity information 510 may include device identity, guest(s) identity, user(s) identity, and/or application(s) identity. As an example, in an SDN implementation, the identity related information for user identity may be in the form of certificates, signatures, tokens, or even segments of block chain—all of which may be updated as frequently as every write, read, execute, or packet send/receive. The solicited identity information 510 (the current information and updates) is communicated and written to the policy library 345. The identity manager 325 may receive updates to application identities (e.g., allow or deny) that can be communicated and written to the policy library 345 for use by the confidence level determination engine 315.

The permission manager 330 tracks and maintains permission information 515 during start-up, operations, and whenever new permission information is received. The permission information 515 (the current information and updates) is communicated and written to the policy library 345 (e.g., pushed by the permission manager 330 to the policy library 345 or pulled by the policy library 345). The permission manager 330 receives updates from the policy manager 335. An update is associated with modifications to specific permissions that were changed during runtime. For instance, the user may have Read/Write access during boot and the confidence level determination engine 315 changes this based on actions of the user to only Read. The policy manager 335 would update the policy to Read Only and monitor this. The permission manager 330 receives such a change and updates the permission. The permission manager 330 may not have enforcement ability (e.g., in some cases enforcement is through the policy manager 335) but is responsible for maintaining the changes in the policy library 345. The confidence level determination engine 315 can use historical information to make decisions.

The integrity monitor 320 analyzes log data (from the logging 164) such as identifying occurrences when system elements (user, applications, operating systems, and/or resources) attempt to circumvent any policy configuration associated with the identity information (e.g., certificates, signatures, permissions). This information can be flagged and evaluated by the confidence level determination engine 315.

The confidence level determination engine 315 evaluates inputs from internal device information and/or external information to calculate a relative confidence level for a system or user action. The confidence level may be transmitted to the policy manager 335. The policy manager 335 may update one or more policies based on the received confidence level. For instance, an application may be enabled to send data to an endpoint based on the knowledge the application sourced/read the data from the right location in memory.

In the example of FIG. 1, the enforced policies allow the authenticated user to use the application 1 and application 3 but not application 2.

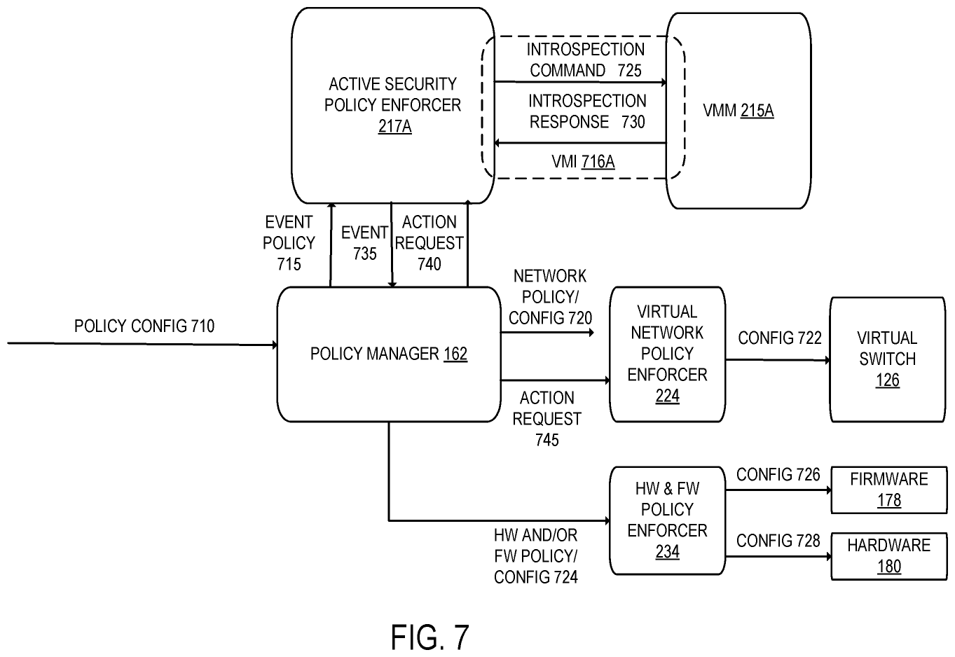

FIG. 7 is a block diagram that illustrates policy enforcement according to some embodiment. The policy manager receives policy configuration 710. The received policy configuration 710 can be received from local configuration (e.g., through an API, command line interface (CLI), etc.) or received remotely. The policy configuration 710 may be an active security policy, a virtual network policy, a hardware or firmware policy, or other policy that affects the operation of the virtualized system. The policy configuration 710 may be a policy that is applicable to each guest OS or guest application, or may be specific to one or more virtual machines, guest operating systems, guest applications, and/or guest processes. The policy configuration 710 may specify the virtual machine, guest operating system, guest application, and/or guest process for which the policy is applicable. The policy manager determines where to install the policy in question.

In some embodiments, the policy manager pushes a new or updated policy to the determined policy enforcer by sending an update policy action to that policy enforcer. The policy manager can also revoke a policy associated with a specific policy enforcer by sending an update policy action to that policy enforcer. As represented in FIG. 7, the policy manager pushes an event policy 715 to the active security policy enforcer 217A, pushes a network policy/configuration 720 to the virtual network policy enforcer 224, and pushes a hardware and/or firmware policy 724 to the hardware and firmware policy enforcer 234. These policies include the action requested (e.g., to install or update a policy) and may include one or more parameters to specify how to execute the action (e.g., what process for which the policy is applicable, what guest operating system or guest application for which the policy is applicable, etc.).

The policy enforcers receive and install the policies. For instance, after receiving the network policy/configuration 720 from the policy manager, the virtual network policy enforcer 224 installs the network configuration 722 to the virtual switch 126. The configuration may be for configuring VLANs, assigning virtual Ethernet devices, creating/updating allow/deny lists for source/destination ports, creating/updating allow/deny lists for source/destination IP addresses, creating/updating allow/deny lists for protocol(s), creating/updating allow/deny lists for certain port numbers, rate limiting from any port, and/or disconnecting any port.

In the case of the hardware and firmware policy enforcer 234, after receiving the hardware and/or firmware policy/configuration 724, the hardware and firmware policy enforcer 234 installs the firmware configuration 726 to the firmware 178 and installs the hardware configuration 728 to the hardware 180. An example firmware configuration may be used for updating or enabling a firmware secure boot configuration. By way of example, a hardware policy may cause a hardware device to be unavailable to a particular guest operating system or guest application.

In the case of the active security policy enforcer 217A, the installed policy may take the form of <EVENT>, [<ARG[0]>, . . . ], do [<ACTION[0]>, . . . ]. The active security policy enforcer 217A determines how to monitor the system to determine if the arguments of the event are met. For instance, if the active security policy includes determining whether a specific file was accessed by a particular process, the active security policy enforcer 217A may use the VMI 216A to introspect the kernel to determine if the specific file has been accessed. The active security policy enforcer 217A sends an introspection command 725 through the VMI 216A to the VMM 215A to introspect the guest. The VMM 215A in turn programs the hardware. For instance, the VMM 215A programs the hardware to trap certain events. The VMM 215A sends an introspection response 730 to the active security policy enforcer 217A through the VMI 216A. The introspection response 730 (sometimes referred to as a callback) may report that the event has occurred. The active security policy enforcer 217A receives the reporting of the event and determines whether the policy event received from the policy manager has been met. If so, the active security policy enforcer 217A transmits the event message 735 to the policy manager.

Based on the event message, the policy manager determines whether a policy has been violated and if so, what action(s) to take. The policy manager may transmit action requests to policy enforcers, such as after an event has been detected in the system. For example, the action request 740 may be sent to the active security policy enforcer 217A, and the action request 745 may be sent to the virtual network policy enforcer 224. The action request is a synchronous request and includes the action requested and may include one or more parameters to specify how to execute the action. For example, a Kill Task action may include a process identifier (pid) parameter that specifies which task to terminate. Depending on the particular action, action requests can be sent to policy enforcers (e.g., ASPE, virtual network policy enforcer, hardware and firmware policy enforcer) or be carried out by the policy manager itself. For instance, a log event action request may be performed by the policy manager itself. Policy enforcers accept action requests and perform the requested actions.

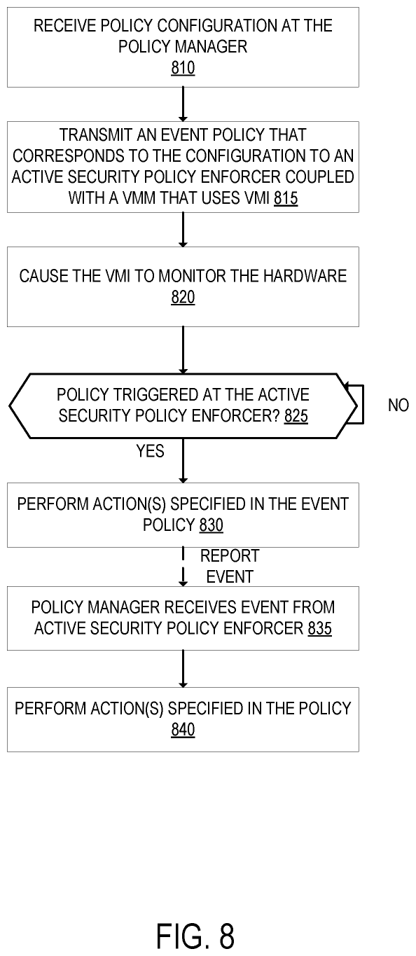

FIG. 8 is a flow diagram that illustrates exemplary operations for enforcing a policy according to an embodiment. The operations of FIG. 8 are described with the exemplary embodiment of FIGS. 1 and 2. However, the operations of FIG. 8 can be performed by embodiments different from that of FIGS. 1 and 2, and the embodiments of FIGS. 1 and 2 can perform operations different from the operations of FIG. 8.

At operation 810, the policy manager receives policy configuration for an active security policy. The received configuration may be received from a user or administrator of the computing device 100, and the received configuration may be received locally or remotely through the management service 221. The received configuration may also be received dynamically as part of an updated policy through the management service 221. The received policy configuration may specify which guest the policy is for. The received policy configuration may define the name of the event (if the arguments are satisfied), a set of one or more arguments that are used to determine whether the event occurs, and a set of one or more actions that are taken if the event occurs.

Next, at operation 815, the policy manager transmits a policy corresponding to the configuration to an active security policy enforcer 217 coupled with a VMM 215 that uses VMI 216. As described above, if there are multiple active security policy enforcers, the policy configuration may specify which active security policy enforcer the policy is for. In some embodiments, the policy is transmitted as an action request to the active security policy enforcer 217.

The active security policy enforcer 217 that receives the policy installs the policy. At operation 820, the active security policy enforcer 217 causes the corresponding VMI 216 to monitor the hardware 180. For example, a policy may be enforced that says that a particular process cannot be run. The VMI 216 may cause the VMM 215 to set a breakpoint that is triggered when that particular process is attempted to be executed and to generate and send an event back to the VMI 216.

Next, at operation 825, the active security policy enforcer 217 determines whether the policy in question has been triggered (e.g., whether the policy has been violated). As described above, there may be multiple arguments that must be satisfied before the policy enforcement is triggered. If the policy enforcement is triggered, then at operation 830 the active security policy enforcer 217 performs the one or more actions specified in the event policy. If the action is to report the event, the reporting of the event is sent to the policy manager. Other actions may be to kill a process, stop an action, send an alert, etc.

If one of the actions is to report the event, then at operation 835, the policy manager receives the reporting of the event from the active security policy enforcer 217. Next, at operation 840, the policy manager performs one or more actions as specified in the policy. The one or more actions may include logging the violation of the policy, blocking the action, removing the offending process, guest operating system, and/or virtual machine from the network, killing the offending process, guest operating system, and/or virtual machine, etc.

As an exemplary policy, a register protection policy may be enforced by the virtualized system. The register protection policy may be created to protect CPU register(s) in one or more ways. For instance, a policy may be created that specifies the number of times a CPU register may be written. As another example, a policy may be created that specifies the value(s) a CPU register may have. As another example, a policy may be created that specifies (through the application of a bitmask) which bits of the CPU register the previous two policies should affect.

In an embodiment, upon the start of the policy manager or after the policy configuration is received by the policy manager, the policy manager pushes a policy to a particular one of the active security policy enforcers 217A-217N for which the policy is to apply. The decision on what guest operating system or application for which the policy is to apply may depend on the configuration of the computing device 100. The policy may specify the number of times a CPU register may be written, the values a CPU register may have, and/or which bits of the CPU register the previous two policies should affect. For the purposes of this example, the policy manager pushes the register protection policy to the active security policy enforcer 217A.

The active security policy enforcer 217A communicates with the corresponding VMM 215A to request that writes to any specified register(s) are trapped to the VMI 216A. For instance, the active security policy enforcer 217A transmits an introspection command 725 through the VMI 216A to the VMM 215A to monitor one or more specified register(s) and trap them to the VMI 216A. The VMM 215A in turn translates the request to a hardware request. For instance, the VMM 215A programs the CPU 182 to serve those requests. The CPU 182 causes writes to those specified register(s) to be trapped to the requesting VMM 215A. Subsequently, the VMM 215A receives these register write traps and then passes these event(s) to the corresponding VMI 216A. Upon each event, the active security policy enforcer 217A stores the relevant state and determines whether the policy has been violated. For instance, if the policy is a limit on the number of writes to a specified register, the active security policy enforcer 217A determines the number of writes to that register. If the policy specifies the possible value(s) that the register may have, the active security policy enforcer 217A compares the value of the pending write to the register against the possible values. If the policy has been violated, one or more remedial actions are taken. For instance, the violation may be logged and/or the write may be blocked.

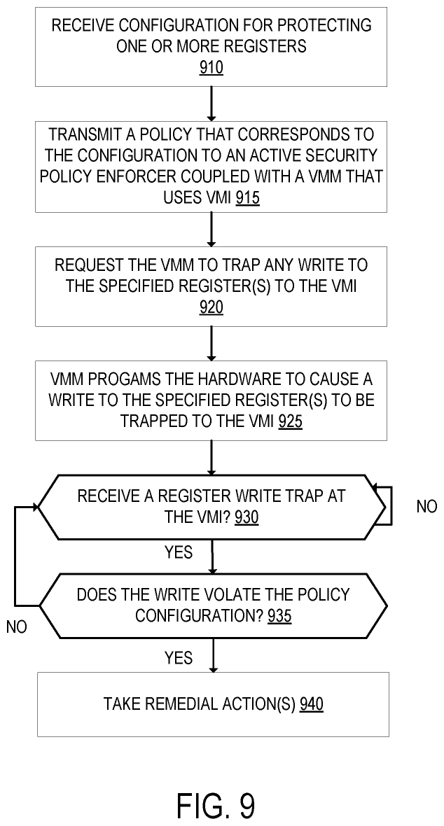

FIG. 9 is a flow diagram that illustrates exemplary operations for enforcing register protection according to an embodiment. The operations of FIG. 9 are described with the exemplary embodiments of FIGS. 1 and 2. However, the operations of FIG. 9 can be performed by embodiments different from that of FIGS. 1 and 2, and the embodiments of FIGS. 1 and 2 can perform operations different from the operations of FIG. 9.

At operation 910, the policy manager receives configuration for protecting one or more registers. The received configuration may be received from a user or administrator of the computing device 100, and the received configuration may be received locally or remotely through the management service 221. The received configuration may specify the number of times a register may be written, the value(s) a register may have, and/or which bits of the register the previous two policies should affect. The received configuration may also specify the guest operating system or guest application for which the policy applies.

Next, at operation 915, the policy manager transmits a policy that corresponds to the configuration to an active security policy enforcer 217 coupled with a VMM 215 that uses VMI 216. In an embodiment, the policy manager pushes the policy to that active security policy enforcer 217 as an action request. Next, at operation 920, the receiving active security policy enforcer 217 requests the VMM 215 to trap any write(s) to the specified register(s) to the VMI 216. Then, at operation 925, the VMM 215 programs the hardware (e.g., the CPU 182) to cause a write to the specified register(s) to be trapped to the VMI 216. Subsequently, when a write to the specified register(s) is being attempted, a register write trap will occur.

After registering for the write trap, the system continuously monitors for the write trap until the configuration is changed and/or the operating system or virtual machine is shut down. At operation 930, if a register write trap is received at the VMI 216, then operation moves to operation 935. If a register write trap is received, the event is passed to the active security policy enforcer 217 that determines, at operation 935, whether the write violates the policy configuration. For instance, if the policy configuration specified that the value of the register could only be one of a set of values and the value being written is not one of those values, then the policy would be violated. As another example, if the policy configuration specified a number of times the register could be written, the active security policy enforcer 217 determines whether this write would exceed that specified number, which would then be a violation of the policy. If the write does not violate the policy, then flow moves back to operation 930. If the write violates the policy, then operation 940 is performed where one or more remedial actions are taken. For instance, the violation can be logged and/or the write can be blocked. The output of operation 940 may be input to the logger (e.g., log or block) and may be an input to the Integrity Monitoring function.

As an exemplary policy, a process allow list policy may be enforced by the virtualized system. The process allow list policy may be created to specify which processes are allowed to be run on the system. The process allow list policy may be received from a user or administrator of the computing device 100, and the received configuration may be received locally or remotely through the management service 221. The received configuration may identify the process(es) that are allowed to run for a particular guest OS. The processes may be identified by their name, or by the complete path of the binary of the process and a secure hash of the target binary.

In an embodiment, upon the start of the policy manager or after the policy configuration is received by the policy manager, the policy manager pushes a policy to a particular one of the active security policy enforcers 217A-217N for which the process allow list is to apply. The decision on what guest operating system or application for which the policy is to apply may depend on the configuration of the computing device 100. For the purposes of this example, the policy manager pushes a process allow list policy to the active security policy enforcer 217A. The policy manager may also push the profile of the target system to the active security policy enforcer 217A, which defines information such as the location of functions within the target kernel. The semantic layer in the VMI 216 uses the provided profile to identify the kernel running in the guest system. Once identified, VMI 216 places a VMI breakpoint on the system calls that are responsible for starting new processes. For instance, in the case of Linux, this would be the execve system call. From this point forward, any attempt by the guest to start a new process will be trapped by VMI 216. In addition, VMI 216 will be able to determine the name of the application that should be started, since this information is generally passed as an argument to the process creation system calls that VMI intercepts.

When a new process is created at the guest, VMI 216 uses the process allow list to determine whether the process is allowed to run or violates the policy. For this purpose, VMI 216 may compare the name of the application that should be run against the list of processes on the process allow list. If the name of the binary is contained in the allow list, execution will continue normally, and the process will run. Otherwise, if the process is not contained in the process allow list, VMI 216 takes remedial action(s). For instance, the violation may be logged and/or the process may be blocked from running by shortcutting the system call and directly returning to the caller with a permission denied error code.

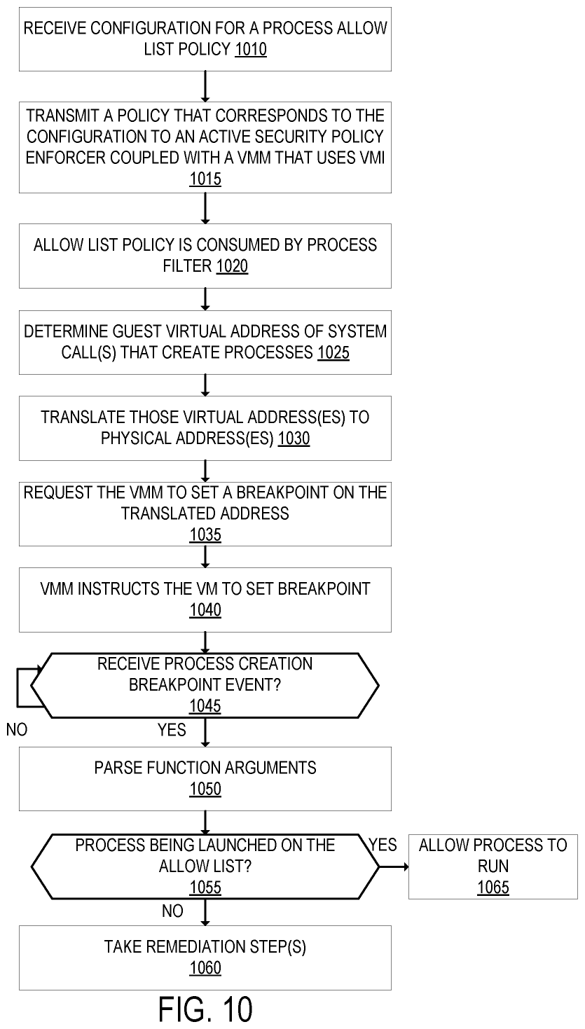

FIG. 10 is a flow diagram that illustrates exemplary operations for enforcing a process allow list policy according to an embodiment. The operations of FIG. 10 are described with the exemplary embodiments of FIGS. 1 and 2. However, the operations of FIG. 10 can be performed by embodiments different from that of FIGS. 1 and 2, and the embodiments of FIGS. 1 and 2 can perform operations different from the operations of FIG. 10.

At operation 1010, the policy manager receives configuration for a process allow list policy. The received configuration may be received from a user or administrator of the computing device 100, and the received configuration may be received locally or remotely through the management service 221. The received configuration may identify the process(es) on the process allow list. The received configuration may also specify the guest operating system or guest application for which the policy applies.

Next, at operation 1015, the policy manager transmits a policy that corresponds to the configuration to an active security policy enforcer 217 coupled with a VMM 215 that uses VMI 216. In an embodiment, the policy manager pushes the policy to that active security policy enforcer 217 as an action request. The policy manager may also push the profile of the target system that allows the active security policy enforcer 217 to identify the guest operating system and make the location of its symbols and functions available to the VMI 216.

Next, at operation 1020, the receiving active security policy enforcer 217 consumes the allow list policy at a process filter. Then, at operation 1025, the active security policy enforcer 217 identifies the guest virtual address of the system call(s) that create process(es). For example, the semantic library may be consulted for the location of the process creation function in the guest OS. After locating the guest virtual address of the system call(s) that create processes, at operation 1030, those virtual address(es) are translated to physical address(es). For instance, the virtual address of the process creation function is translated into a physical address. Next, at operation 1035, the active security policy enforcer 217 requests the VMM 215 to set a breakpoint trap on the translated physical address(es). Next, at operation 1040, the VMM 215 instructs the corresponding VM 208 to set the breakpoints within the guest OS 210.

When a breakpoint is hit (e.g., the process creation function in the guest OS 210 is called), the VMM 215 generates an event that is sent to the VMI 216. In this example, this event is called a process creation breakpoint event. At operation 1045, the active security policy enforcer 217 determines whether a process creation breakpoint event has been received at the VMI 216. The process may loop at operation 1045 until the policy has been removed from the system or until such an event is received. If a process creation breakpoint event has been received, then at operation 1050 the active security policy enforcer 217 parses the function arguments of the process creation system calls to extract the name of the process that is about to run. Next, at operation 1055, the active security policy enforcer 217 determines whether the process being launched is on the process allow list. For instance, the active security policy enforcer 217 compares the name of the process that is about to run against the allow list. If the process that is being launched is on the process allow list, then the process will be allowed to run at operation 1065. If the process that is being launched is not on the process allow list, then one or more remediation steps are taken at operation 1060. For example, the violation may be logged and/or the process creation call may be blocked (e.g., a permission denied error code may be returned to the caller). The output of operation 1060 (e.g., log or block) may be an input to the confidence level determination engine 315 to trigger updates to a specific policy

Although FIG. 10 described the use of a process allow list, a process deny list policy can also be used. In such a case, operations like FIG. 10 are performed with the exception that instead of checking whether the process being launched is on the allow list, a determination is made whether the process being launched is on the deny list. If the process is on the deny list, then remediation steps are taken. If the process is not on the deny list, then the process is allowed to run.

Thus, process allow list policies and/or process deny list policies can be enforced in the virtualization stack, thus isolating it from attack. These embodiments can be used for any unmodified guest OS. Unlike conventional solutions that provide little to no configuration options and instead try to automatically identify malicious or benign binaries that lead to false positives and false negatives, embodiments described herein allow a user or administrator of the system to have complete control over which processes will be blocked and which will be able to run (no false positives and no false negatives). This allows for customization for the environment of the user or administrator.

As another exemplary policy, a driver allow list policy may be enforced by the virtualized system. The driver allow list policy may be created to specify which drivers are allowed to be loaded on the system. The driver allow list policy may be received from a user or administrator of the computing device 100, and the received configuration may be received locally or remotely through the management service 221. The received configuration may identify the driver(es) that are allowed to be loaded for a particular guest OS. The drivers may be identified by their name, or by the complete path of the driver and a secure hash of the driver.

In an embodiment, upon the start of the policy manager or after the policy configuration is received by the policy manager, the policy manager pushes a policy to a particular one of the active security policy enforcers 217A-217N for which the driver allow list is to apply. The decision on what guest operating system or application for which the policy is to apply may depend on the configuration of the computing device 100. For the purposes of this example, the policy manager pushes a driver allow list policy to the active security policy enforcer 217. The policy manager may also push the profile of the target system to the active security policy enforcer 217, which defines information such as the location of functions within the target kernel. The semantic layer in the VMI 216 uses the provided profile to identify the kernel running in the guest system. Once identified, VMI 216 places a VMI breakpoint on the system calls that are responsible for loading new drivers. For instance, in the case of Linux, this would be the init_module system call. From this point forward, any attempt by the guest to load a new driver will be trapped by VMI 216. In addition, VMI 216 will be able to determine the name of the driver that should be loaded, since this information is generally passed as an argument to the driver load system calls that VMI 216 intercepts.

When a new driver is attempted to be loaded at the guest, VMI 216 uses the driver allow list to determine whether the driver is allowed to load or violates the policy. For this purpose, VMI 216 may compare the name of the driver that should be loaded against the list of drivers on the drivers allow list. If the name of the driver is contained in the allow list, execution will continue normally, and the driver will be loaded. Otherwise, if the driver is not contained in the driver allow list, VMI 216 takes remedial action(s). For instance, the violation may be logged and/or the driver may be blocked from running by shortcutting the system call and directly returning to the caller with a permission denied error code.

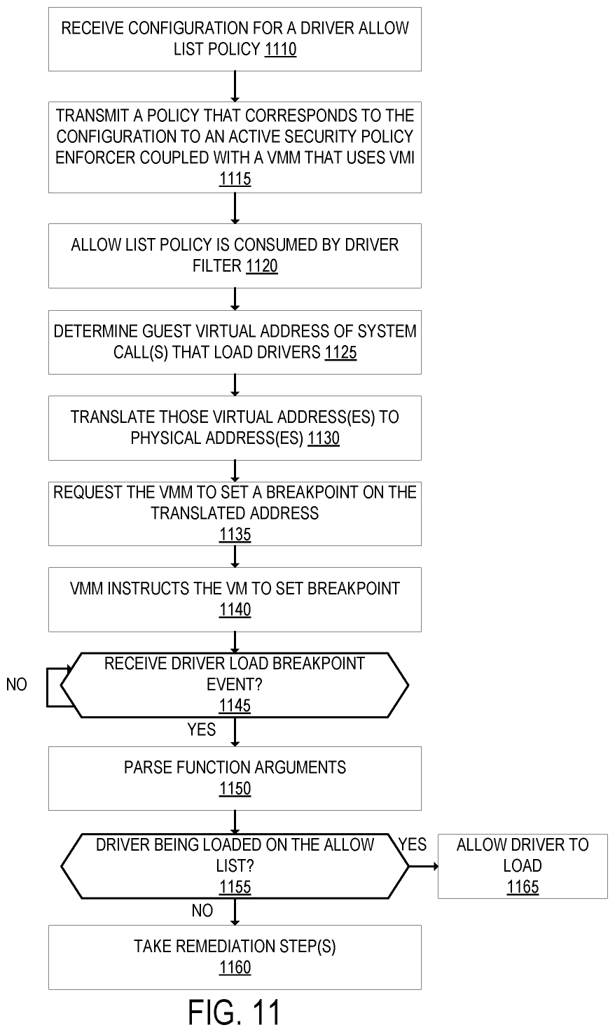

FIG. 11 is a flow diagram that illustrates exemplary operations for enforcing a driver allow list policy according to an embodiment. The operations of FIG. 11 are described with the exemplary embodiments of FIGS. 1 and 2. However, the operations of FIG. 11 can be performed by embodiments different from that of FIGS. 1 and 2, and the embodiments of FIGS. 1 and 2 can perform operations different from the operations of FIG. 11.

At operation 1110, the policy manager receives configuration for a driver allow list policy. The received configuration may be received from a user or administrator of the computing device 100, and the received configuration may be received locally or remotely through the management service 221. The received configuration may identify the driver(s) on the driver allow list. The received configuration may also specify the guest operating system or guest application for which the policy applies.

Next, at operation 1115, the policy manager transmits a policy that corresponds to the configuration to an active security policy enforcer 217 coupled with a VMM 215 that uses VMI 216. In an embodiment, the policy manager pushes the policy to that active security policy enforcer 217 as an action request. The policy manager may also push the profile of the target system that allows the active security policy enforcer 217 to identify the guest operating system and make the location of its symbols and functions available to the VMI 216.

Next, at operation 1120, the receiving active security policy enforcer 217 consumes the allow list policy at a driver filter. Then, at operation 1125, the active security policy enforcer 217 identifies the guest virtual address of the system call(s) that load drivers. For example, the semantic library may be consulted for the location of the driver load system calls (e.g., init_module system call). After locating the guest virtual address of the system call(s) that load drivers, at operation 1130, those virtual address(es) are translated to physical address(es). For instance, the virtual address of the driver loading system call is translated into a physical address. Next, at operation 1135, the active security policy enforcer 217 requests the VMM 215 to set a breakpoint trap on the translated physical address(es). Next, at operation 1140, the VMM 215 instructs the corresponding VM 208 to set the breakpoints within the guest OS 210.

When a breakpoint is hit (e.g., the driver loading system call in the guest OS 210 is called), the VMM 215 generates an event that is sent to the VMI 216. In this example, this event is called a driver load breakpoint event. At operation 1145, the active security policy enforcer 217 determines whether a driver load breakpoint event has been received at the VMI 216. The process may loop at operation 1145 until the policy has been removed from the system or until such an event is received. If a driver load breakpoint event has been received, then at operation 1150 the active security policy enforcer 217 parses the function arguments of the driver loading system calls to extract the name of the driver that is to be loaded. Next, at operation 1155, the active security policy enforcer 217 determines whether the driver that is to be loaded is on the driver allow list. For instance, the active security policy enforcer 217 compares the name of the driver that is to be loaded against the allow list. If the driver that is to be loaded is on the driver allow list, then the driver will be allowed to load at operation 1165. If the driver that is to be loaded is not on the driver allow list, then one or more remediation steps are taken at operation 1160. For example, the violation may be logged and/or the driver load system call may be blocked (e.g., a permission denied error code may be returned to the caller). The output of operation 1165 may be an input to the confidence level determination engine 315 to trigger updates to a specific policy.

Although FIG. 11 described the use of a driver allow list, a driver deny list policy can also be used. In such a case, operations like FIG. 11 are performed with the exception that instead of checking whether the driver that is to be loaded is on the allow list, a determination is made whether the driver to be loaded is on the deny list. If that driver is on the deny list, then remediation steps are taken. If the driver is not on the deny list, then the driver is allowed to load.

Thus, driver allow list policies and/or driver deny list policies can be enforced in the virtualization stack, thus isolating it from attack. These embodiments can be used for any unmodified guest OS. Unlike conventional solutions that provide little to no configuration options and instead rely on certificates to determine whether a driver is trustworthy, embodiments described herein allow a user or administrator of the system to have complete control over which drivers will be blocked and which will be able to load. This allows for customization for the environment of the user or administrator.

As another exemplary policy, a data structure integrity policy may be enforced by the virtualized system. The data structure integrity policy may be created to specify which in-guest data structure(s) are to be integrity protected, with or without the assistance of the virtual machine. The data structure integrity policy may be received from a user or administrator of the computing device 100, and the received configuration may be received locally or remotely through the management service 221. The received configuration may identify the data structure(s) that are to be integrity protected. The configuration may specify the memory access permissions to be enforced. The configuration may also specify the action that should be taken in case of a policy violation.

In an embodiment, upon the start of the policy manager or after the policy configuration is received by the policy manager, the policy manager pushes a policy to a particular one of the active security policy enforcers 217A-217N for which the data structure integrity policy is to apply. The decision on what guest operating system or application for which the policy is to apply may depend on the configuration of the computing device 100. For the purposes of this example, the policy manager pushes a data structure integrity policy to the active security policy enforcer 217. The policy manager may also push the profile of the target system to the active security policy enforcer 217, which defines information such as the location (in the guest virtual memory) of the given data structures. The semantic layer in the VMI 216 uses the provided profile to identify the guest operating system and the guest virtual addresses of the identified data structures for which integrity is to be protected.

By leveraging VMM, the active security policy enforcer 217 can use VMI 216 to configure the provided memory access permissions in the second level address translation tables to enforce unauthorized accesses to the particular data structure. Each time the guest violates the policy, a memory access violation event is received and the active security policy enforcer 217 takes one or more actions according to the configuration. For instance, the violation may be logged (the memory permission may be at least temporarily granted and the instruction that generated the memory violation may be single-stepped) and execution continues, or the violation may be logged and the process terminated.

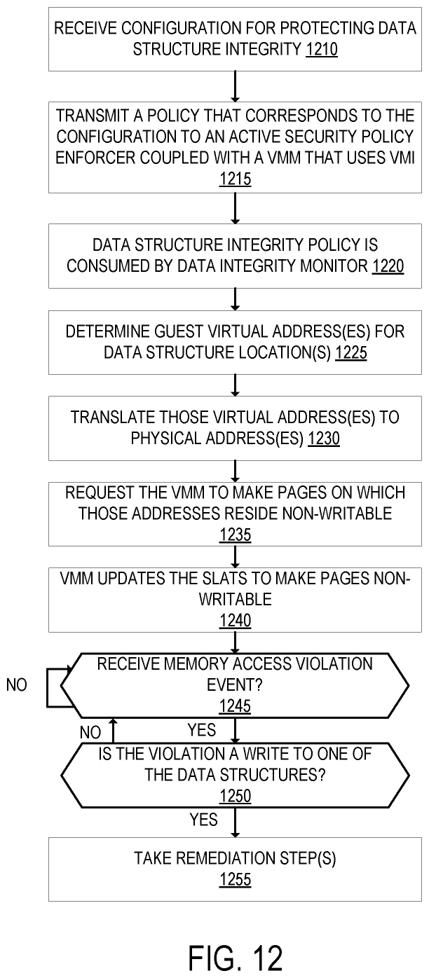

FIG. 12 is a flow diagram that illustrates exemplary operations for enforcing a data structure integrity policy according to an embodiment. The operations of FIG. 12 are described with the exemplary embodiment of FIGS. 1 and 2. However, the operations of FIG. 12 can be performed by embodiments different from that of FIGS. 1 and 2, and the embodiments of FIGS. 1 and 2 can perform operations different from the operations of FIG. 12.

At operation 1210, the policy manager receives configuration for a data structure integrity policy. The received configuration may be received from a user or administrator of the computing device 100, and the received configuration may be received locally or remotely through the management service 221. The received configuration may identify the data structure(s) to integrity protect. The configuration may specify the memory access permissions to be enforced. The configuration may also specify the action that should be taken in case of a policy violation. The received configuration may also specify the guest operating system or guest application for which the policy applies.

Next, at operation 1215, the policy manager transmits a policy that corresponds to the configuration to an active security policy enforcer 217 coupled with a VMM 215 that uses VMI 216. In an embodiment, the policy manager pushes the policy to that active security policy enforcer 217 as an action request. The policy manager may also push the profile of the target system that allows the active security policy enforcer 217 to identify the guest operating system to the VMI 216.

Next, at operation 1220, the receiving active security policy enforcer 217 consumes the data structure integrity policy at a data integrity monitor. Then, at operation 1225, the active security policy enforcer 217 determines the guest virtual address(es) of the location(s) of the data structure(s) identified in the data structure integrity policy. Next, at operation 1230, those virtual address(es) are translated to physical address(es). Next, at operation 1235, the active security policy enforcer 217 requests the VMM 215 to make pages on which those physical address(es) reside non-writable. Next, at operation 1240, the VMM 215 updates the second level address translation tables to make the pages non-writable. The VMI 216 will be notified each time the guest violates the configured memory access permissions when accessing the identified data structures. Thus, if a memory access violation is received, the VMM 215 generates an event that is sent to the VMI 216. In this example, the event is called a memory access violation event. At operation 1245, the active security policy enforcer 217 determines whether a memory access violation event has been received at the VMI 216. The process may loop at operation 1245 until the policy has been removed from the system or until such an event is received. If a memory access violation event has been received, then at operation 1250 the active security policy enforcer 217 determines if the violation is a write to one of the specified data structures. If the violation is not a write to one of the specified data structures, in an embodiment the flow moves back to operation 1245. If the violation is a write to one of the specified data structures, then one or more remediation steps are taken at operation 1255. For instance, the violation may be logged (the memory permission may be at least temporarily granted and the instruction that generated the memory violation may be single-stepped) and execution continues, or the violation may be logged and the process terminated. The output of this operation may be an input to the confidence level determination engine 315 to trigger updates to a specific policy.

Thus, data structure integrity can be enforced in the virtualization stack, thus isolating it from attack. These embodiments can be used for any unmodified guest OS. Example data structures that may be protected include the system call table or the interrupt vector table, which can be abused by adversaries to take control over the system.

As another exemplary policy, a code integrity policy may be enforced by the virtualized system. The code integrity policy may be created to protect a set of code regions, such as system call handlers. The policy configuration may specify a list of code functions, the integrity of which is to be protected using virtualization techniques described herein. The code integrity policy may be received from a user or administrator of the computing device 100, and the received configuration may be received locally or remotely through the management service 221. The received configuration may identify the list of code functions that are to be integrity protected. The configuration may specify the memory access permissions to be enforced. The configuration may also specify the action that should be taken in case of a policy violation.

In an embodiment, upon the start of the policy manager or after the policy configuration is received by the policy manager, the policy manager pushes a policy to a particular one of the active security policy enforcers 217A-217N for which the code integrity policy is to apply. The decision on what guest operating system or application for which the policy is to apply may depend on the configuration of the computing device 100. For the purposes of this example, the policy manager pushes a code integrity policy to the active security policy enforcer 217. The policy manager may also push the profile of the target system to the active security policy enforcer 217, which defines information such as the location (in the guest virtual memory) of the code regions. The semantic layer in the VMI 216 uses the provided profile to identify the guest operating system and the guest virtual addresses of the identified code regions for which integrity is to be protected.

By leveraging VMM, the active security policy enforcer 217 can use VMI 216 to configure the provided memory access permissions in the second level address translation tables to enforce unauthorized accesses to the particular code. Each time the guest violates the policy, a memory access violation event is received and the active security policy enforcer 217 takes one or more actions according to the configuration. For instance, the violation may be logged (the memory permission may be at least temporarily granted and the instruction that generated the memory violation may be single-stepped) and execution continues, or the violation may be logged and the process terminated.

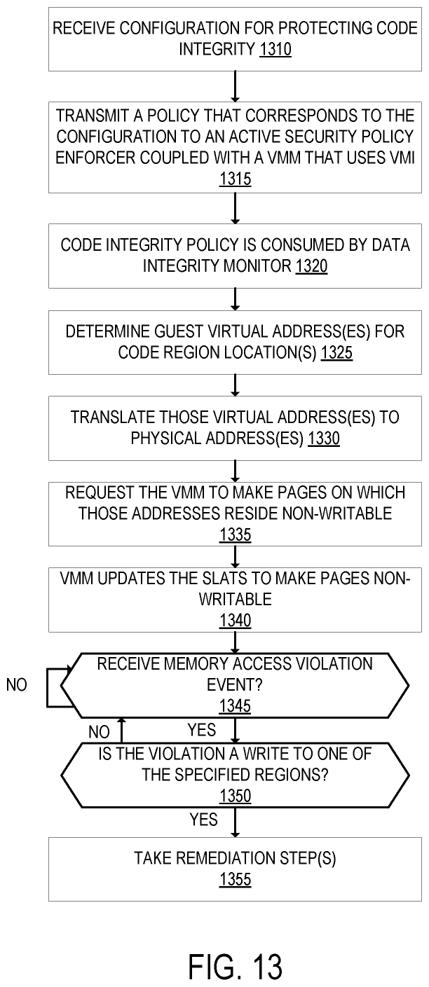

FIG. 13 is a flow diagram that illustrates exemplary operations for enforcing code integrity policy according to an embodiment. The operations of FIG. 13 are described with the exemplary embodiments of FIGS. 1 and 2. However, the operations of FIG. 13 can be performed by embodiments different from that of FIGS. 1 and 2, and the embodiments of FIGS. 1 and 2 can perform operations different from the operations of FIG. 13.

At operation 1310, the policy manager receives configuration for a code integrity policy. The received configuration may be received from a user or administrator of the computing device 100, and the received configuration may be received locally or remotely through the management service 221. The received configuration may identify a list of code functions to integrity protect. The configuration may specify the memory access permissions to be enforced. The configuration may also specify the action that should be taken in case of a policy violation. The received configuration may also specify the guest operating system or guest application for which the policy applies.

Next, at operation 1315, the policy manager transmits a policy that corresponds to the configuration to an active security policy enforcer 217 coupled with a VMM 215 that uses VMI 216. In an embodiment, the policy manager pushes the policy to that active security policy enforcer 217 as an action request. The policy manager may also push the profile of the target system that allows the active security policy enforcer 217 to identify the guest operating system to the VMI 216.

Next, at operation 1320, the receiving active security policy enforcer 217 consumes the code integrity policy at a data integrity monitor. Then, at operation 1325, the active security policy enforcer 217 determines the guest virtual address(es) of the location(s) of the code region(s) identified in the code integrity policy. Next, at operation 1330, those virtual address(es) are translated to physical address(es). Next, at operation 1335, the active security policy enforcer 217 requests the VMM 215 to make pages on which those physical address(es) reside non-writable. Next, at operation 1340, the VMM 215 updates the second level address translation tables to make the pages non-writable. The VMI 216 will be notified each time the guest violates the configured memory access permissions when accessing the identified code regions. Thus, if a memory access violation is received, the VMM 215 generates an event that is sent to the VMI 216. In this example, the event is called a memory access violation event. At operation 1345, the active security policy enforcer 217 determines whether a memory access violation event has been received at the VMI 216. The process may loop at operation 1345 until the policy has been removed from the system or until such an event is received. If a memory access violation event has been received, then at operation 1350 the active security policy enforcer 217 determines if the violation is a write to one of the specified code regions. If it is, then one or more remediation steps are taken at operation 1355. For instance, the violation may be logged (the memory permission may be at least temporarily granted and the instruction that generated the memory violation may be single-stepped) and execution continues, or the violation may be logged and the process terminated. Thus, code integrity can be enforced in the virtualization stack, thus isolating it from attack. These embodiments can be used for any unmodified guest OS. If the violation is not a write to one of the specified code regions, then in an embodiment the flow moves back to operation 1345. The output of this operation may be an input to the confidence level determination engine 315 to trigger updates to a specific policy.

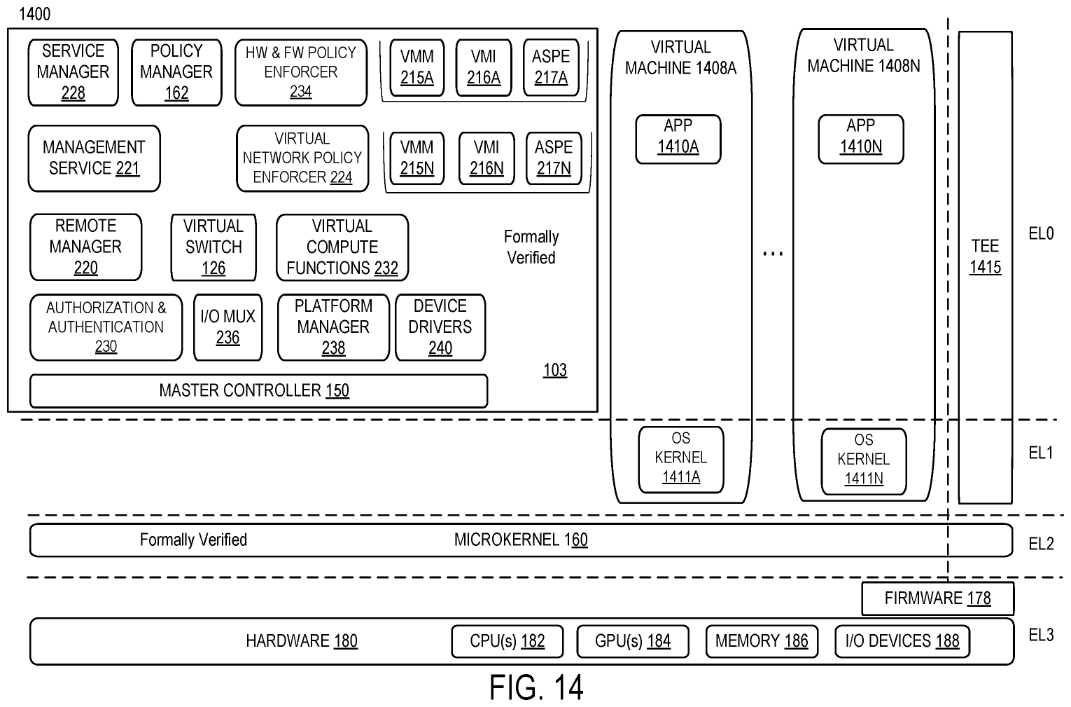

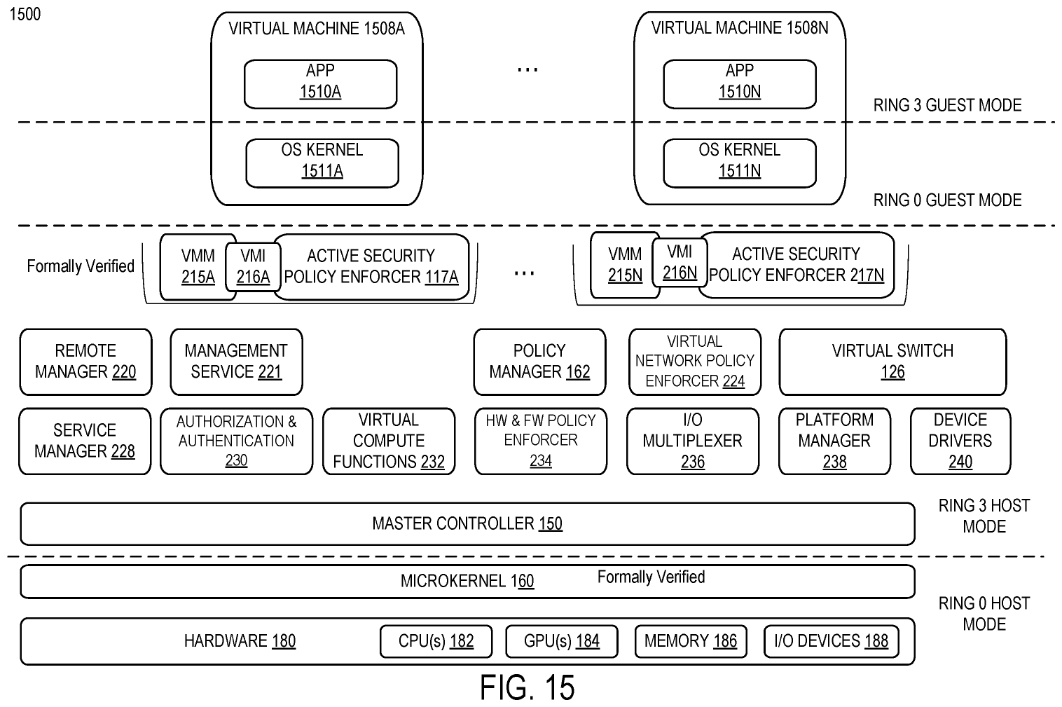

The exemplary architecture shown in FIG. 2 can be used in different hardware architectures including ARM architectures and x86 architectures. For example, FIG. 14 is a block diagram that shows an exemplary implementation for the formally verified trusted computing base as shown in FIG. 2 for an ARM architecture, and FIG. 15 is a block diagram that shows an exemplary implementation for the formally verified trusted computing base as shown in FIG. 2 for an x86 architecture.

The exemplary implementation shown in FIG. 14 is for an ARM architecture. The computing device 1400 is a computing device like the computing device 100 and has an ARM architecture (e.g., ARMv8). ARM defines different levels of privilege as exception levels. Each exception level is numbered, and the higher levels of privilege have higher numbers. Exception level 0 (EL0) is known as the application privilege level. All the hypervisor components except for the microkernel 160 are in the exception level 0. The applications 910A-910N executing within the virtual machines 908A-908N are also in exception level 0. The OS kernels 911A-911N executing within the virtual machines 908A-908N are in exception level 1 (EL1), which is the rich OS exception level. The formally verified microkernel 160 is in exception level 2 (EL2), which is the hypervisor privilege level. The firmware 178 and the hardware 180 are at exception level 3 (EL3), which is the firmware privilege level and the highest privilege level. The trusted execution environment (TEE) 1415 is at the exception level 0 and 1 for the trusted services and kernel respectively.

The exemplary implementation shown in FIG. 15 is for an x86 architecture. The computing device 1500 is a computing device like the computing device 100 and has an x86 architecture. The x86 architecture defines four protection rings but most modern architectures use two privilege levels, rings 0 and 3 and may run in guest or host mode. For instance, the guest OS kernels 1011A-1011N running in the virtual machines 1008A-1008N respectively run in the most privileged level (guest kernel mode, ring 0), and the guest applications 1010A-1010N run in a lesser privileged level (guest user mode, ring 3). The formally verified microkernel 160 runs in the most privileged level of the host (host kernel mode, ring 0), and the other components of the hypervisor run in a lesser privileged level (host user mode, ring 3).

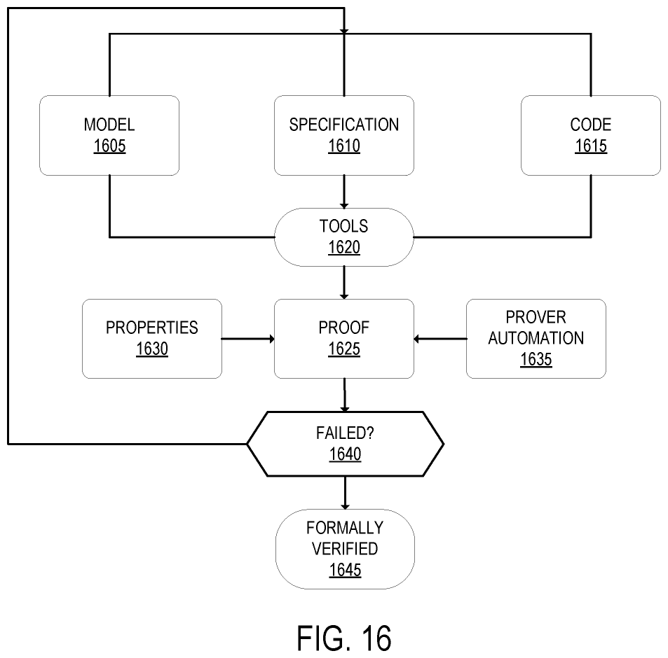

Multiple components of the virtualization layer are formally verified components in some embodiments. Formal verification proves (or disproves) the correctness of intended code using formal methods of mathematics. Formal verification guarantees that a system is free of programming errors. FIG. 16 is a flow chart that illustrates an exemplary method of formal verification that may be used in some embodiments. A model 1605 of the code 1615 is created. The model 1605 is the functional implementation corresponding to the code 1615. The specification 1610 is a formal specification of the properties of the code 1615 expressed in a mathematical language. The code 1615 itself may be coded in a way that is architecture to be formally verified. The tools 1620 may include tools for converting the code 1615 into file(s) suitable for an interactive theorem prover 1635. The properties 1630 include any security properties or any theorems used for proving the code 1615. If the proof 1625 fails at block 1640, then the code 1615 is not formally verified. If the proof is verified, then the code 1615 is deemed to be formally verified 1645.

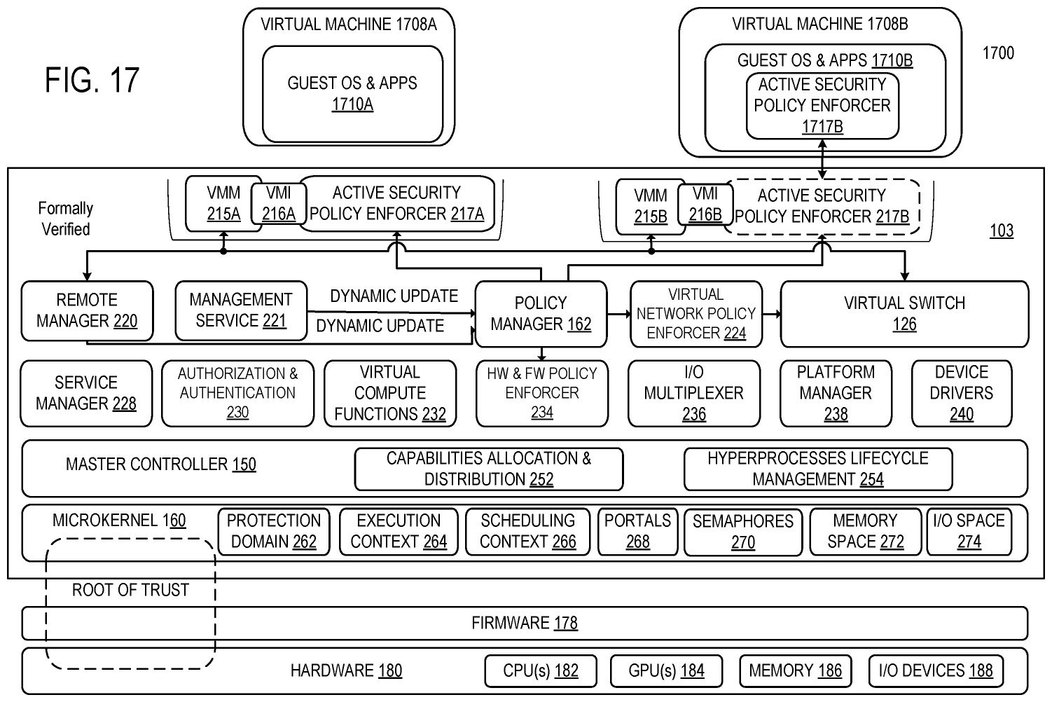

FIG. 17 illustrates an example use of the formally verified trusted computing base with active security and policy enforcement, according to an embodiment. The computing device 1700 is like the computing device 100. However, in the example shown in FIG. 17, there are two virtual machines 1208A and 1208B that are running, where the virtual machine 1208A has an unmodified guest operating system and applications 1210A, and the virtual machine 1208B has a piece of software installed to assist in the active security policy enforcement (the active security policy enforcer 1217B). Thus, the policy enforcement including the active security policy enforcement that impacts the guest operating system and applications 1210A are performed by the virtualization system like as described with respect to FIG. 1. However, the active security policy enforcement for the guest operating system and applications 1210B are performed in coordination with the guest. In such a case, memory encryption may be in use for the guest operating system and applications 1210B such that outside of the guest there is no visibility of the memory. In an embodiment, the active security policy enforcer 1217B is an image of the active security policy enforcer 217B. The active security policy enforcer 217B controls the active security policy enforcer 1217B. For instance, the active security policy enforcer 217B communicates active security policies to the active security policy enforcer 1217B. The active security policy enforcer 1217B may also perform VMI and provide at least read or write to the main memory of the guest.

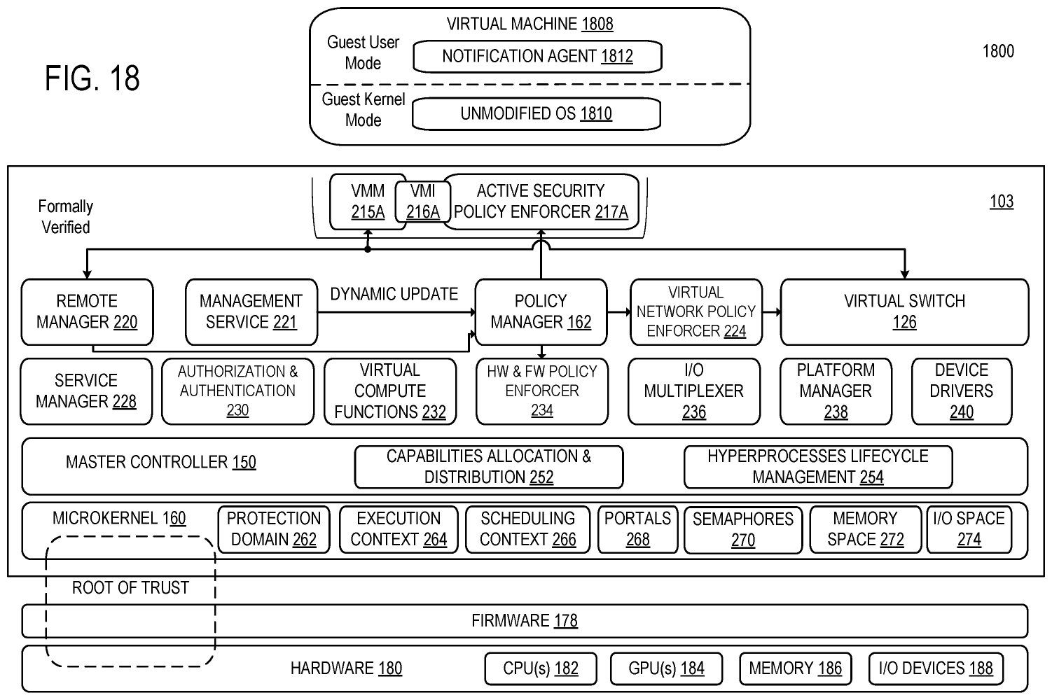

FIG. 18 illustrates an example use of the formally verified trusted computing base with active security and policy enforcement, according to an embodiment. The computing device 1800 is like the computing device 100. However, in the example shown in FIG. 18, the virtual machine 1808 includes an unmodified OS 1810 running in guest kernel mode and a notification agent 1812 that runs in the guest user mode space. The notification agent 1812 is used to notify a user of an event that has been detected by the virtualization system. The policy manager may communicate with the notification agent 1812. The event may be those in which the user has configured some interest in receiving and/or that an administrator of the system has configured. For instance, a popup may occur when a violation of a policy has occurred such as a detection of malware. Although FIG. 18 illustrates a single virtual machine, there may be notification agents running on multiple virtual machines at the same time.

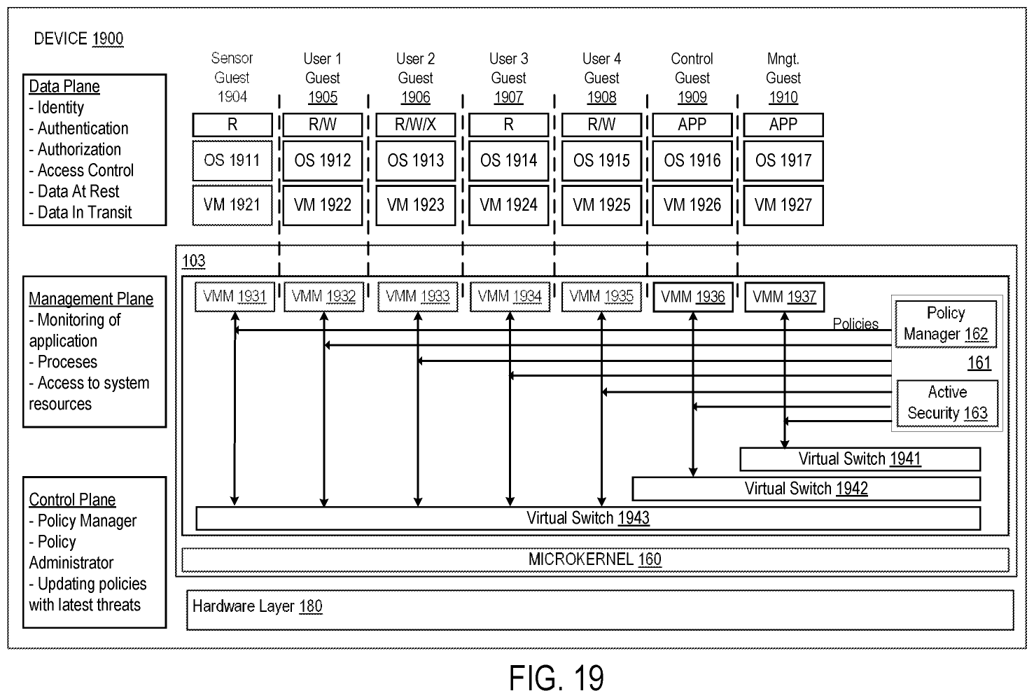

FIG. 19 illustrates an example use of the zero trust endpoint device according to an embodiment. The computing device 1900 is like the computing device 100. The computing device 1900 includes a virtualized system with multiple guest VMs and multiple system VMs. For example, VMs 1921-1925 are guest VMs on which OS 1911-1915 are running respectively. Each virtual machine as a separate VMM like as described with reference elsewhere herein. Thus, the VMs 1921-1927 are associated with the VMMs 1931-1937 respectively. The VM 1921 is used for a sensor guest 1904 (e.g., an IoT sensor). The sensor guest 1904 has Read permissions. The VMs 1922-1925 are used for different users (user 1 guest 1905, user 2 guest 1906, user 3 guest 1907, user 4 guest 1908 respectively). User 1 guest has Read and Write permissions. User 2 guest has Read, Write, and Execute permissions. User 3 Guest has Read permissions. User 4 guest has Read and Write permissions. The VM 1926 and VM 1927 are system VMs on which OS 1916 and OS 1917 are running respectively. The VM 1926 is for running a control guest 1919 application. The VM 1927 is for running a management guest 1910 application.

The policy manager 162 installs policies for the VMMs 1931-1937 to manage communication paths and enable fine grain control over source and destination using multiple virtual switches (the virtual switches 1941-1943) that are configured to support internal communication paths. All network connections from the hosted guests are routed through the VMs to manage communication paths and enable fine grain control over source and destination using multiple virtual switches that are configured to support internal communication paths. For instance, a first virtual switch may be configured to allow communication between a first set of one or more VMMs and VMs, and a second switch may be configured to allow communication only between a second set of one or more VMMs and VMs. In this case, since multiple SDN connections may be in existence simultaneously, guests only receive what they are approved to receive and are unable to gain any insights into other traffic in/out of the device as well as transiting to other guests.

FIG. 19 shows functionality provided by the data plane including identity, authentication, authorization, access control, data at rest, and data in transit. FIG. 19 also shows functionality of the management plane including monitoring of applications, processes, and access to system resources. FIG. 19 also shows functionality of the control plane including the policy manager, policy administrator, and updating policies with the latest threats.

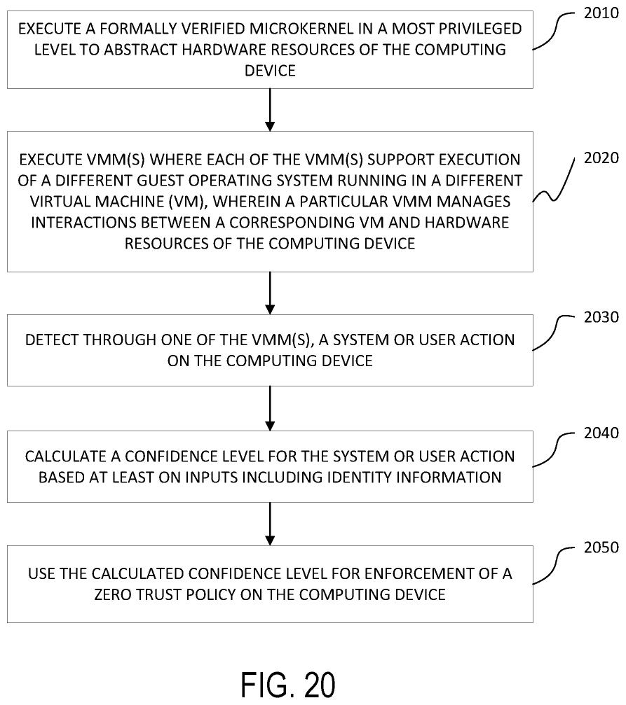

FIG. 20 is a flow diagram that illustrates exemplary operations for zero trust policy enforcement on the endpoint according to an embodiment. The operations of FIG. 20 are described with the exemplary embodiment of FIGS. 1 and 2. However, the operations of FIG. 20 can be performed by embodiments different from that of FIGS. 1 and 2, and the embodiments of FIGS. 1 and 2 can perform operations different from the operations of FIG. 20.

At operation 2010, the computing device 100 executes a formally verified microkernel 160 in a most privileged level to abstract hardware resources of the computing device 100. The formally verified microkernel 160 may control access to the hardware resources using explicit authorization. Next, at operation 2020, the computing device 100 executes VMM(s) where each of the VMM(s) runs as a user-level application in a different address space on top of the formally verified microkernel. Each VMM supports execution of a different guest operating system running in a different virtual machine (VM). A particular VMM manages interactions between a corresponding VM and hardware resources of the computing device. The VMM(s) may be formally verified.

At operation 2030, the computing device 100 detects through one of the VMM(s), a system or user action on the computing device 100. Such a system or user action may include a system call, network call, session initialization, or other specified information/triggers that are identified and/or captured.

At operation 2040, the computing device calculates a confidence level for the system or user action based at least on inputs including identity information. The identity information can include the identity of the computing device, identity of the virtual machine associated with the system or user action, identity of the guest operating system associated with the system or user action, identity of an application associated with the system or user action, and/or identity of a user associated with the system or user action. The identity of the computing device may include the MAC address of the device, device identity information that is extracted from the CPU, information contained in BIOS/UEFI, and/or information contained in FPGA silicon. Additionally, or alternatively, the device identity information can include cryptographic based certificates/keys that are loaded in other silicon on the CPU or the device itself such as external credential devices. The identity of the user may take one or more forms. For instance, a user may be a physical person or a user may be an external device that is relying of the functionality associated with the applications/communications hosted in a particular guest. The user identity may include information related to specific tokens, certificates, signatures, etc. The user identity may be generated based on query/response tied with multi-factor authentication actions. User identity information may change during a particular session based on the information received from the SDN management plane and/or assessments regarding trust and the results of the confidence level determination engine. In an SDN implementation, the identity related information for user identity may be in the form of certificates, signatures, tokens, or even segments of block chain—all of which may be updated as frequently as every write, read, execute, or packet send/receive.

Calculating the confidence level for the system or user action may further be based on permissions information including user permissions, guest permissions, device permissions, and/or application permissions. The user permissions generally start with a baseline that is received and established upon successful authentication with a back-end Identity and Access Management (IDAM) capability. The user permissions may be continually evaluated by the confidence level determination engine to assess the suitability of the permissions relative to the Confidence Level change. Permissions may include Read/Write/Execute/Connect/Disconnect/Open/Close/Request/Access/Publish/Deny based on the actions attempted.

The device permissions may include the configuration file of the formally verified trusted computing base and/or information gathered as the device builds connections with SDN end-points. These permissions can be modified based on time, space, and/or permissions associated with the guests, users, applications, and/or connections to system resources. The device permissions may also depend on credentials/certificates that are presented via external resources and/or the calculated confidence level from external management plane capabilities provided via the SDN VM. The device permissions may be subject to the assessed integrity of the boot process, such as was the boot image encrypted and decrypted in a well-formed process, did the necessary hash/certificate checks occur and pass, etc.

The guest(s) permissions are controlled by policies that enable verification and validation of system actions. Guest permissions include what virtual devices are allocated to the guest as well as the virtual resources allocated to the devices. The allocation of physical resources to each guest are maintained as part of the VMM configuration. While some of the permissions for a guest come directly from the VMM configuration, other permissions can be managed by the Active Security policies instantiated during boot time. Updates to active security policies can be pushed by a guest administrator and may include a variety of access control updates.

Application permissions are assigned either as part of the boot process based on pre-configurations, based on validity of application signatures, based on guest identity/permissions, based on external input from SDN VM management, or based on real-time confidence level results.

Calculating the confidence level for the system or user action may further be based on integrity information including occurrences when system elements have attempted to circumvent a policy configuration. For example, the integrity monitor may analyze log data (from the logging 164) and identify occurrences when system elements (user, applications, operating systems, and/or resources) attempt to circumvent any policy configuration associated with the identity information (e.g., certificates, signatures, permissions).

At step 2050, the computing device 100, uses the calculated confidence level for enforcement of a zero trust policy on the computing device. For instance, the calculated confidence level may be transmitted to the policy manager 335. The policy manager 335 may update one or more policies based on the received confidence level. For instance, an application may be enabled to send data to an endpoint based on the knowledge the application sourced/read the data from the right location in memory.

The techniques shown in the figures can be implemented using code and data stored and executed on one or more computing devices. Such computing devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such computing devices typically include a set of one or more hardware processors coupled to one or more other components, such as one or more I/O devices (e.g., storage devices (non-transitory machine-readable storage media), a keyboard, a touchscreen, a display, and/or network connections). The coupling of the set of processors and other components is typically through one or more busses and bridges (also termed as bus controllers). Thus, the storage device of a given computing device typically stores code and/or data for execution on the set of one or more processors of that computing device.

In the preceding description, numerous specific details are set forth to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the preceding description and the claims, the terms “coupled” and “connected,” along with their derivatives, may be used. These terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A computing device, comprising:
a plurality of hardware resources including a set of one or more hardware processors, memory, and storage devices, wherein the storage devices include instructions that when executed by the set of hardware processors, cause the computing device to operate a virtualized system, the virtualized system including:
a set of one or more virtual machines (VMs) that execute one or more guest operating systems;
a set of one or more virtual machine monitors (VMMs) corresponding to the set of one or more VMs respectively, wherein a particular VMM manages interactions between the corresponding VM and physical resources of the computing device;
a formally verified microkernel running in a most privileged level to abstract hardware resources of the computing device; and
an isolated environment that is addressable only from the formally verified microkernel, the isolated environment including:
a policy manager that manages a set of one or more policies for the virtualized system including installing the set of policies to a policy enforcement point, wherein the set of policies includes one or more zero trust policies;
a confidence level determination engine that calculates a confidence level for a system or user action based at least on inputs including identity information, and provides the calculated confidence level to the policy manager, wherein the policy manager updates one or more of the set of policies based on the provided confidence level; and
the policy enforcement point enforces the set of policies.

2. The computing device of claim 1, wherein the identity information includes identity of the computing device, identity of the virtual machine associated with the system or user action, identity of the guest operating system associated with the system or user action, identity of an application associated with the system or user action, and/or identity of a user associated with the system or user action.

3. The computing device of claim 1, wherein the confidence level calculation is further based on permissions information including user permissions, guest permissions, device permissions, and/or application permissions.

4. The computing device of claim 1, wherein the confidence level calculation is further based on integrity information including occurrences when system elements have attempted to circumvent a policy configuration.

5. The computing device of claim 1, wherein the policy enforcement point includes an active security policy enforcer that uses virtual machine introspection (VMI) for introspection of at least some of the hardware resources including one or more hardware processors and enforces the set of policies based at least in part on the introspection.

6. The computing device of claim 1, wherein the formally verified microkernel controls access to the hardware resources using explicit authorization.

7. The computing device of claim 1, wherein the policy manager and the confidence level determination engine are formally verified.

8. The computing device of claim 1, wherein one of the one or more VMs is a system VM that supports execution of a software defined networking (SDN) connection application that connects to an SDN solution.

9. A method in a computing device, comprising:
executing a formally verified microkernel in a most privileged level to abstract hardware resources of the computing device;
executing a plurality of virtual machine monitors (VMMs), wherein each of the plurality of VMMs runs as a user-level application in a different address space on top of the formally verified microkernel, wherein each of the plurality of VMMs support execution of a different guest operating system running in a different virtual machine (VM), wherein a particular VMM manages interactions between a corresponding VM and hardware resources of the computing device, and wherein the plurality of VMMs are formally verified;
detecting through one of the VMMS, a system or user action on the computing device;
calculating a confidence level for the system or user action based at least on inputs including identity information; and
using the calculated confidence level for enforcement of a zero trust policy on the computing device.

10. The method of claim 9, wherein the identity information includes an identity of the computing device, identity of the virtual machine associated with the system or user action, identity of the guest operating system associated with the system or user action, identity of an application associated with the system or user action, and/or identity of a user associated with the system or user action.

11. The method of claim 9, wherein calculating the confidence level for the system or user action is further based on permissions information including user permissions, guest permissions, device permissions, and/or application permissions.

12. The method of claim 9, wherein calculating the confidence level for the system or user action is further based on integrity information including occurrences when system elements have attempted to circumvent a policy configuration.

13. The method of claim 9, wherein the formally verified microkernel controls access to the hardware resources using explicit authorization.

14. The method of claim 9, wherein calculating the confidence level for the system or user action is performed for each system call.

15. The method of claim 9, further comprising:
updating the zero trust policy on the computing device based on the calculated confidence level.

16. A non-transitory machine-readable storage medium that provides instructions that, if executed by a processor of a computing device, will cause said processor to perform operations comprising, comprising:
executing a formally verified microkernel in a most privileged level to abstract hardware resources of the computing device;
executing a plurality of virtual machine monitors (VMMs), wherein each of the plurality of VMMs runs as a user-level application in a different address space on top of the formally verified microkernel, wherein each of the plurality of VMMs support execution of a different guest operating system running in a different virtual machine (VM), wherein a particular VMM manages interactions between a corresponding VM and hardware resources of the computing device, and wherein the plurality of VMMs are formally verified;
detecting through one of the VMMS, a system or user action on the computing device;
calculating a confidence level for the system or user action based at least on inputs including identity information; and
using the calculated confidence level for enforcement of a zero trust policy on the computing device.

17. The non-transitory machine-readable storage medium of claim 16, wherein the identity information includes an identity of the computing device, identity of the virtual machine associated with the system or user action, identity of the guest operating system associated with the system or user action, identity of an application associated with the system or user action, and/or identity of a user associated with the system or user action.

18. The non-transitory machine-readable storage medium of claim 16, wherein calculating the confidence level for the system or user action is further based on permissions information including user permissions, guest permissions, device permissions, and/or application permissions.

19. The non-transitory machine-readable storage medium of claim 16, wherein calculating the confidence level for the system or user action is further based on integrity information including occurrences when system elements have attempted to circumvent a policy configuration.

20. The non-transitory machine-readable storage medium of claim 16, wherein the formally verified microkernel controls access to the hardware resources using explicit authorization.

21. The non-transitory machine-readable storage medium of claim 16, wherein calculating the confidence level for the system or user action is performed for each system call.

22. The non-transitory machine-readable storage medium of claim 16, wherein the operations further comprise:
updating the zero trust policy on the computing device based on the calculated confidence level.
